(19) United States
(12) Patent Application Publication
(10) Pub. No.: US 2007/0226257 A1
(43) Pub. Date: Sep. 27, 2007

(54) Internet Based Animal Registration System

(76) Inventor: Robert G. Yarnall Jr, Kimberton, PA (US)

Correspondence Address: RATNERPRESTIA, P O BOX 980, VALLEY FORGE, PA, 19482-0980, US

(21) Appl. No.: 11/597,783

(22) PCT Filed: May 31, 2005
(86) PCT No.: PCT/US05/18975

§ 371 Date: Nov. 27, 2006

Related U.S. Application Data
(60) Provisional application No. 60/575,588, filed on May 28, 2004.

(51) Int. Cl. G06F 7/00

(52) U.S. Cl. 707/104.1

(57) ABSTRACT

A method for use with a computer system for registering information by at least one authorized user relating to at least one animal. Information is entered into the computer system about the user. Information is entered into the computer system about the animal. The information about the user is correlated with the information about the animal and the correlated information is stored in the computer system.

### CROSS REFERENCE TO RELATED APPLICATION

This application claims the benefit of priority to U.S. Provisional Application No. 60/575,588, filed May 28, 2004, the contents of which are incorporated by reference herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to systems and methods for registering animal information. More particularly, this invention relates to an Internet based animal registration system and method that allows an owner of an animal, and others so authorized, to register animals and to access the information after the animal is registered.

### BACKGROUND OF THE INVENTION

Breeders, owners, veterinarians, and government agencies need to know and understand a great deal of information about animals in their possession, custody, control, and ownership. For example, they need to know an animal's physical and biological attributes, genetic makeup, inheritable diseases and disorders, and communicable diseases and disorders. Animals are often moved from one location to another location during their lifetimes. Consequently, they may be come into contact with infected animals, eat defective feed, and infect other animals. They may also be treated by more than one veterinarian. At times, it may be important for a current owner of the animal, for a current veterinarian treating the animal, or for a government agency to have access to historical information about the animal.

U.S. Pat. No. 5,478,990 issued to Montanari et al. describes a process of tracking food products and/or food supplements coupled with a system of generating additional labels as required for identifying various portions of food products. Furthermore, Montanari's patent describes a system that requires the owner of an animal to maintain their records on their own computer. Additionally, Montanari's system of generating labels adds great cost to individuals utilizing Montanari's system.

U.S. Pat. No. 5,900,818 issued to Lemnell describes a system for indicating the direction and tracking of hunting dogs while engaged in hunting activities. Lemnell's patent is comprised of a radio frequency transmitting device.

U.S. Pat. No. 6,323,771 issued to Payne et al. describes a method of identifying animals involving the use of a universal identification scheme. Payne's universal identification scheme requires that a unique formatted number be assigned to the animal and said number would link the animal to a geographic indexing method.

U.S. Pat. No. 6,424,727 issued to Musgrave et al. describes a system and method of animal identification and animal transaction authorization using iris patterns. Musgrave's patent requires the use of expensive equipment and sophisticated computer programs to analyze the iris patterns matching animal to owner.

U.S. Pat. No. 6,375,612 issued to Guichon et al. describes a method and system of monitoring animals. Guichon collects data determining the position of each animal within a specific area at predetermined intervals. Guichon then analyses the collected data to determine at least one physical condition of the animal.

U.S. Pat. No. 6,154,213 issued to Rennison et al. describes a method of operating a “search engine” on the World Wide Web.

U.S. Pat. No. 6,537,213 issued to Dodds describes a phenotype database of non-livestock pet animals and their laboratory test data. Dodds analyzes the test results of individual animals and compares the results to previously entered data of the animal and/or to genetically related non-livestock pet animals.

U.S. Pat. No. 6,360,215 issued to Judd et al. describes a method and apparatus for retrieving documents based on information other than document content. Similar to the previously described Rennison patent, Judd's patent is an alternate method of operating a “search engine” on the World Wide Web.

U.S. Patent Application Publication No. 2004/0039258 filed by Dodds describes a method of obtaining and electronically delivering a diagnosis of the health of an animal through a combination of computerized data and human interpretation. A fluid sample from the animal is reported through an Internet network to a clinical pathologist who makes a diagnosis. Additional information may be entered into the computer and an integrated report is electronically communicated to a client.

### SUMMARY OF THE INVENTION

The invention provides a method for use with a computer system for registering information by at least one authorized user relating to at least one animal. According to one aspect of the invention, information is entered into the computer system about the user; information is entered into the computer system about the animal; and the information about the user is correlated with the information about the animal and the correlated information is stored in the computer system.

The invention also provides a method for use with a computer system for storing a breeding history of an animal offspring in a computer system. According to another aspect of the invention, information is entered into the computer system identifying the male animal that is bred to produce the offspring; information is entered into the computer system identifying the female animal that is bred to produce the offspring; information is entered into the computer system identifying the offspring animal produced by the male animal and the female animal; the information about the male animal, the female animal, and the offspring animal are correlated in the computer system; and the correlated information is stored in the computer system.

These and other aspects will become apparent in view of the following detailed description.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is an illustration of a secure User Login screen in accordance with an exemplary embodiment of the present invention;

FIG. 2 is an illustration of an exemplary User Login screen in accordance with another exemplary embodiment of the present invention;

FIG. 3 is a flow diagram illustrating the operation of a User Login screen's random security code generator in accordance with an exemplary embodiment of the present invention;

FIG. 4 is a graphic representation and illustration of an exemplary code that may be produced by the random security code generator illustrated in FIG. 3;

FIG. 5 is a flow diagram illustrating an operation of an exemplary User Login screen's random security code generator coupled with an exemplary random background image generator in accordance with an exemplary embodiment of the present invention;

FIGS. 6-8 are exemplary and illustrative graphic representations of background images that may be produced by a background image generator illustrated in FIG. 5;

FIG. 9 is a graphic representation and illustration of an exemplary embodiment of a User Login screen's randomly generated security code combined with an illustrative randomly generated background image described in FIG. 5;

FIG. 10 is an overview illustrating a manner in which a user may access the present invention;

FIG. 11 is an overview illustrating a manner in which a user may access the present invention coupled to an automated electronic payment processing company;

FIG. 12 is an exemplary flow diagram illustrating User Login screen's security logic features coupled with an ability to sort and direct users to predetermined security levels and applications in accordance with an exemplary embodiment of the present invention;

FIG. 13 is an exemplary flow diagram illustrating an ability to sort and direct users to predetermined security levels and applications in accordance with an exemplary embodiment of the present invention;

FIG. 14 is a graphic representation of an animal that carries a microchip used for unique identification;

FIG. 15 is a graphic representation of an exemplary method showing how a government representative may acquire the microchip identification number of an animal using a universal or other microchip scanner;

FIG. 16 is a graphic representation of an animal that has an illustrative tattoo that may be used for unique identification;

FIG. 17 is a graphic representation of an animal that has a tag attached to its collar for unique identification;

FIG. 18 is a graphic representation of an animal's DNA sample used for unique identification;

FIG. 19 is a graphic representation of the transfer of ownership of an animal;

FIG. 20 is an illustration of an indexed ownership table of an animal in accordance with an exemplary embodiment of the present invention;

FIG. 21 is an illustration of an indexed owner's address table in accordance with an exemplary embodiment of the present invention;

FIG. 22 is an illustration of an indexed facility location address table in accordance with an exemplary embodiment of the present invention;

FIG. 23 is an illustration of an indexed identification table of an animal in accordance with an exemplary embodiment of the present invention;

FIG. 24 is an illustration of an indexed veterinary health record table of an animal in accordance with an exemplary embodiment of the present invention;

FIG. 25 is an illustration of an indexed animal owner table that may be used to show multiple animals owned at different locations in accordance with an exemplary embodiment of the present invention;

FIG. 26 is an illustration of an indexed contagious disease-tracking table of an animal that may be used in accordance with an exemplary embodiment of the present invention;

FIG. 27 is a graphic representation of an owner of an animal initiating the breeding of a male and female to produce offspring;

FIG. 28 is a graphic representation of a female animal producing offspring after being bred;

FIG. 29 is a graphic representation of a transfer of ownership of an animal's offspring to a new owner;

FIG. 30 is an overview flow chart illustrating a manner in which an animal's owner who is a breeder may use the present invention;

FIG. 31 is a graphic overview illustrating a manner in which a new owner of offspring from an animal may use an exemplary embodiment of the present invention;

FIG. 32 is a graphic overview illustrating a manner in which a government representative may use an exemplary embodiment of the present invention;

FIG. 33 is a graphic overview illustrating a manner in which a veterinarian may use an exemplary embodiment of the present invention;

FIG. 34 is a graphic overview illustrating a manner in which multiple users may access an exemplary embodiment of the present invention;

FIG. 35 is a graphic exemplary overview illustrating a manner in which a government representative may use a wireless mobile method to access predetermined computer programs, processes, and data fields of an exemplary embodiment of the present invention;

FIG. 36 is a graphic exemplary overview illustrating a manner in which a government representative may use a wireless mobile method to access predetermined computer programs and data fields coupled with a printer of an exemplary embodiment of the present invention;

FIG. 37 is a graphic exemplary overview illustrating a manner in which a government representative may use a wireless mobile method to access predetermined computer programs and data fields coupled with a portable battery supply or other power supply of an exemplary embodiment of the present invention;

FIG. 38 is a graphic exemplary overview illustrating a manner in which a government representative may use a wireless mobile method to access predetermined computer programs and data fields of an exemplary embodiment of the present invention;

FIG. 39 is a graphic exemplary overview illustrating how an exemplary embodiment of the present invention may be coupled to a user data storage device allowing a user to store a copy of the user's data at the user's location;

FIG. 40 is a flow diagram illustrating how an animal owner may access and use predetermined, exemplary, functions of the present invention in accordance with an exemplary embodiment of the present invention;

FIG. 41 is a flow diagram illustrating how an animal owner may access and use predetermined, exemplary, functions of the present invention coupled with an automated electronic payment processing company in accordance with an exemplary embodiment of the present invention;

FIG. 42 is a flow diagram illustrating how a veterinarian may access and use predetermined, exemplary, functions in accordance with an exemplary embodiment of the present invention;

FIG. 43 is a flow diagram illustrating how a veterinarian may access and use predetermined, exemplary, functions in accordance with an exemplary embodiment of the present invention coupled with an exemplary automated electronic payment processing company;

FIG. 44 is a flow diagram illustrating how a government representative may access and use predetermined, exemplary, functions in accordance with an exemplary embodiment of the present invention;

FIG. 45 is a flow diagram illustrating how a government representative may access and use predetermined, exemplary, functions in accordance with an exemplary embodiment of the present invention coupled with an automated electronic payment processing company;

FIG. 46 is a graphic overview illustrating the table in FIG. 22 in accordance with an exemplary embodiment of the present invention;

FIG. 47 is a graphic overview illustrating how an exemplary embodiment of the present invention may link multiple owners of animals to one or more physical locations;

FIG. 48 is a graphic overview illustrating the table in FIG. 22 in accordance with an exemplary embodiment of the present invention;

FIG. 49 is a graphic representation of other living creators that may be tracked by an exemplary embodiment of the present invention after having an identification placed on or in them;

FIG. 50 is a flow diagram illustrating exemplary information that may be entered into, stored, and retrieved in accordance with an exemplary embodiment of the present invention.

FIG. 51 is an illustration of a Registration Application Form in accordance with an exemplary embodiment of the invention;

FIG. 52 is an illustration of a Official Registration Certificate in accordance with an exemplary embodiment of the invention;

FIG. 53 is a graphic representation of an owner of an animal initiating the breeding of a male and female to produce offspring;

FIG. 54 is a graphic representation of a female animal producing offspring after being bred;

FIG. 55 is a graphic representation of the transfer of ownership of an animal's offspring to a new owner;

FIG. 56 is an overview illustrating a manner in which a user may access an exemplary embodiment of the present invention when it is coupled to an automated electronic payment processing company in accordance with an exemplary embodiment of the invention;

FIG. 57 is an overview illustrating a manner in which multiple users may access an exemplary embodiment of the present invention when it is coupled to an automated electronic payment processing company in accordance with an exemplary embodiment of the invention;

FIG. 58 is an illustration of a Breeding Record Screen prior to a user providing information in accordance with an exemplary embodiment of the invention;

FIG. 59 is an illustration of a Select Species field on a Breeding Record Screen that may be accessed by a user in accordance with an exemplary embodiment of the invention;

FIG. 60 is an illustration of a Select Sub-Species field on a Breeding Record Screen that may be accessed by a user in accordance with an exemplary embodiment of the invention;

FIG. 61 is an illustration of a Select Male Name field on a Breeding Record Screen that may be accessed by a user in accordance with an exemplary embodiment of the invention;

FIG. 62 is an illustration of select Female Name field on a Breeding Record Screen that may be accessed by a user in accordance with an exemplary embodiment of the invention;

FIG. 63 is an illustration of a Breeding Record field and date input files on a Breeding Record Screen that may be accessed by a user in accordance with an exemplary embodiment of the invention;

FIG. 64 is an illustration of a completed Breeding Record Screen, including an illustrative number of males and females born, that may be accessed by a user in accordance with an exemplary embodiment of the invention;

FIG. 65 is an illustration of another Breeding Record Screen providing a system and a method to indicate use of an outside male in accordance with an exemplary embodiment of the invention;

FIG. 66 is an illustration of information that may be added to a Breeding Record when an outside male is used for breeding in accordance with an exemplary embodiment of the invention;

FIG. 67 is an illustration of an Outside Male Breeding Record Queue in accordance with an exemplary embodiment of the invention;

FIG. 68 is an illustration of a screen allowing an owner of an animal to request verification of information about another animal that was bred to the owner's animal in accordance with an exemplary embodiment of the invention;

FIG. 69 illustrates an Outside Mating Verification form in accordance with an exemplary embodiment of the invention; and

FIG. 70 illustrates a Foundation Animal Record form in accordance with an exemplary embodiment of the invention.

FIG. 71 is an illustration of a screen that a user may use to begin a process of registering an animal online;

FIG. 72 is an illustration of a screen that a user may see after the user has selected Prepaid Sticker illustrated in FIG. 71 as a mode of payment;

FIG. 73 is an illustration of a screen that a user may see after the user has selected an online payment method illustrated in FIG. 71 as a mode of payment;

FIG. 74 is an illustration of a screen of an exemplary registration process;

FIG. 75 is an illustration of another screen of an exemplary registration process;

FIG. 76 is an illustration of yet another screen of an exemplary registration process;

FIG. 77 is an illustration of still another screen of an exemplary registration process;

FIG. 78 is an illustration of yet a further screen of an exemplary registration process;

FIGS. 79A and 79B comprise a flow chart illustrating an exemplary method of generating a Registration Application Number and an Internet Access Security Code; and

FIG. 80 is a flow chart illustrating an exemplary embodiment for generating a Registration Certificate for an animal.

### DETAILED DESCRIPTION OF THE INVENTION

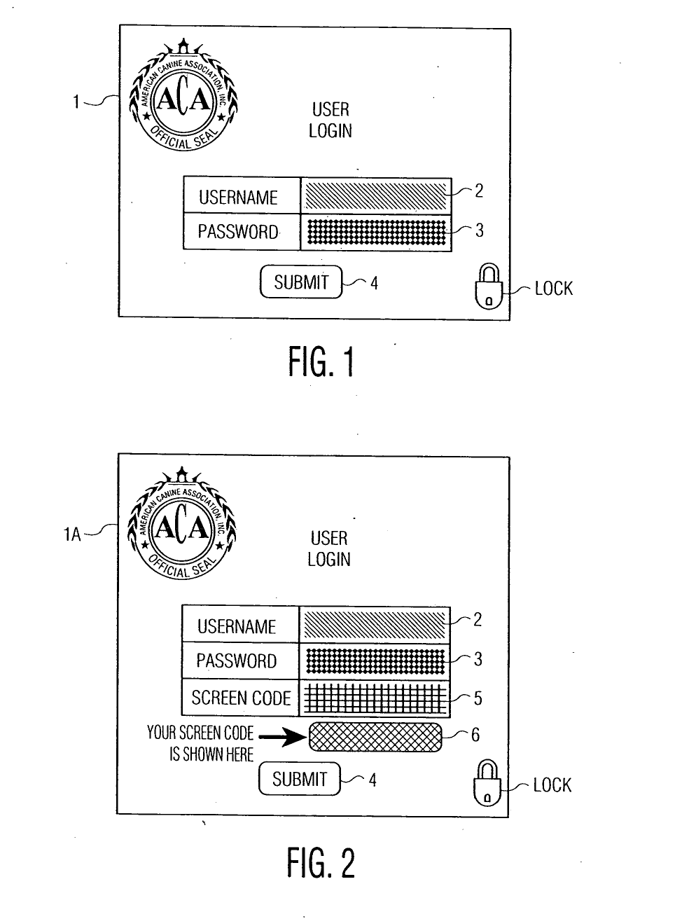

FIG. 1 is an illustration of a secure User Login screen in accordance with an exemplary embodiment of the present invention. More particularly, FIG. 1 shows an exemplary graphic representation of User Screen Shot (1) as seen when accessing an exemplary embodiment of the present invention. Username Data Entry Area (2) allows an authorized user of the system to enter a pre-authorized username. Password Data Area (3) allows an authorized user of the system to enter a predetermined password linked with the predetermined username. A user of the system may also be referred to as a client of the system. It will be understood that any reference to any user in this specification includes an authorized user. Submit Button (4) keys the system to submit the data entered in Username Data Entry Area (2) and Password Data Area (3) to present to an authorized user the invention's system via a communication network such as the Internet. Connection to the network may be via well-known means, such as hard-wired or wireless communication channels. Security Image Lock (LOCK) may inform the user of the system that all data is securely encrypted and that well-known and established security protocols are being properly observed by the Internet based system of the exemplary invention.

FIG. 2 is an illustration of an exemplary User Login screen in accordance with another exemplary embodiment of the present invention. More particularly, FIG. 2 shows an exemplary graphic representation of User Screen Shot (1A) as seen when accessing an exemplary embodiment of the present invention. The Screen Shot (1A) illustrated in FIG. 2 is similar to the Screen Shot (1) illustrated in FIG. 1 except that Screen Shot (1A) illustrates the inclusion of Screen Code Data Entry Area (5), which may allow a user to input a code shown to the user in Screen Code Image (6) (described below).

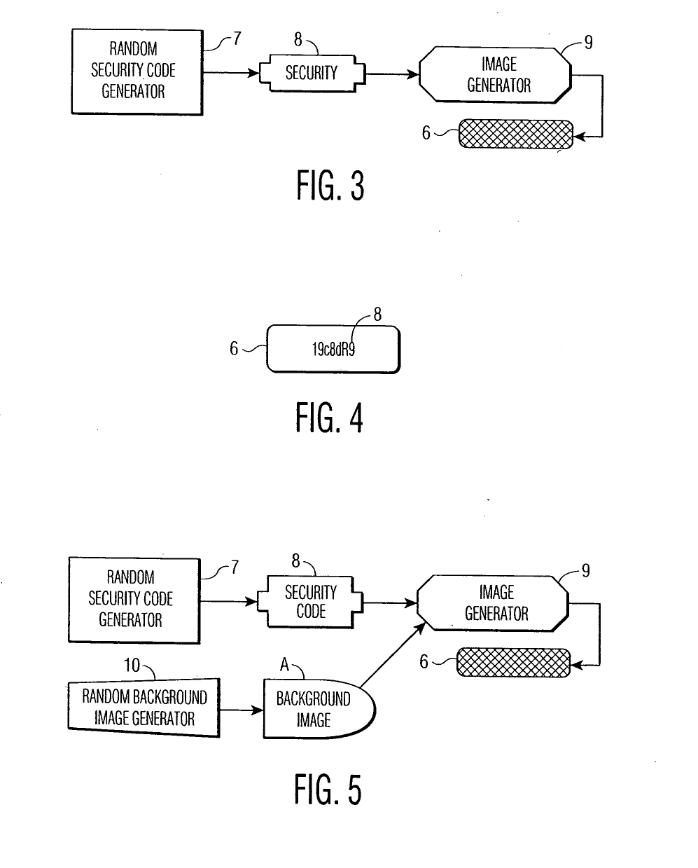

FIG. 3 is a flow diagram illustrating the operation of a User Login screen's random security code generator in accordance with an exemplary embodiment of the present invention. More particularly, FIG. 3 is a flow diagram illustrating how Screen Code Image (6) shown in FIG. 2 may be created. Referring to FIG. 3, a Random Security Code Generator (7) may generate a random Security Code (8). Security Code (8) may be automatically sent to Image Generator (9). Image Generator (9) may convert Security Code (8) into an electronic image, which is in turn sent to Screen Code Image (6) where it may be viewed by the user within Screen Shot 1A as shown in FIG. 2.

FIG. 4 is a graphic representation and illustration of an exemplary code that may be produced by the Random Security Code Generator (7) illustrated in FIG. 3. More particularly, FIG. 4 is an example of a Security Code (8) that may be generated by Random Security Code Generator (7) for use in Screen Code Image (6) as illustrated in FIGS. 2 and 3.

FIG. 5 is a flow diagram illustrating an operation of an exemplary User Login screen's random security code generator coupled with an exemplary random background image generator in accordance with an exemplary embodiment of the present invention. More particularly, FIG. 5 is an exemplary flow diagram illustrating what may happen after Random Security Code Generator (7) generates a Security Code (8). After Random Security Code Generator (7) generates a Security Code (8), the Security Code (8) may be automatically sent to Image Generator (9). Either before, during, or after the generation of Security Code (8), a Random Background Image Generator (10) may generate a Background Image (A) and transmit the Background Image (A) to Image Generator (9). In an exemplary embodiment, Background Image (A) may be a randomly generated image. Image Generator (9) may combine Security Code (8) with Background Image (A) to create an exemplary Screen Code Image (6) that may be viewed by the user as shown in FIG. 2.

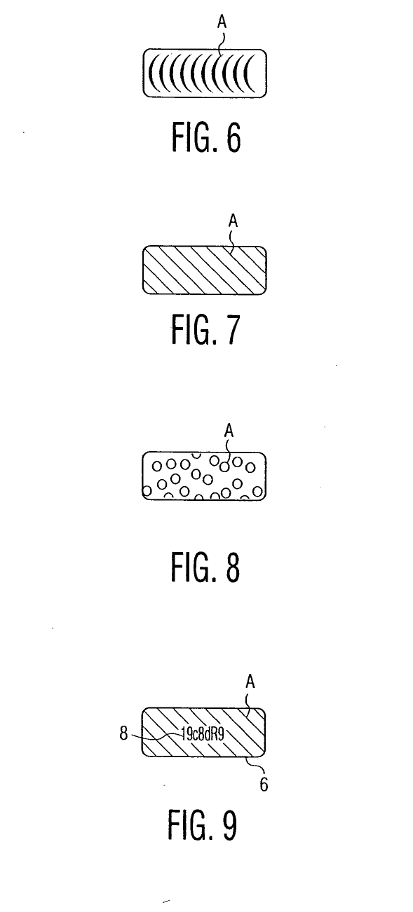

FIGS. 6-8 are exemplary and illustrative graphic representations of background images that may be produced by the Random Background Image Generator (10) illustrated in FIG. 5. FIG. 6 is a graphic representation of an exemplary random Background Image (A) that may be produced by the Random Background Image Generator (10) illustrated in FIG. 5. FIG. 7 is an exemplary graphic representation of another random Background Image (A) that may be produced by Random Background Image Generator (10) illustrated in FIG. 5. FIG. 8 is an exemplary graphic representation of yet another random Background Image (A) that may be produced by Random Background Image Generator (10) illustrated in FIG. 5.

FIG. 9 is an exemplary graphic representation of Screen Code Image (6) as described in FIG. 5. More particularly, FIG. 9 is a graphic representation and illustration of an exemplary embodiment of a User Login screen's randomly generated security code (8) combined with an illustrative randomly generated background image (A) described in FIG. 5. That is, Screen Code Image (6) may comprise a combination of a random Security Code (8) and a random Background Image (A).

The use of a random security code with a random background image may be used in order to reduce the possibility of unauthorized access to the system by an unauthorized person or entity, particularly by a person or entity using an automated hacking system. The system and method may continuously alter the background image each time an authorized user logs onto the system. Continuous alteration may disable automated computer hacking programs from eliminating an image background and using Optical Character Reading (OCR) software to decipher a code.

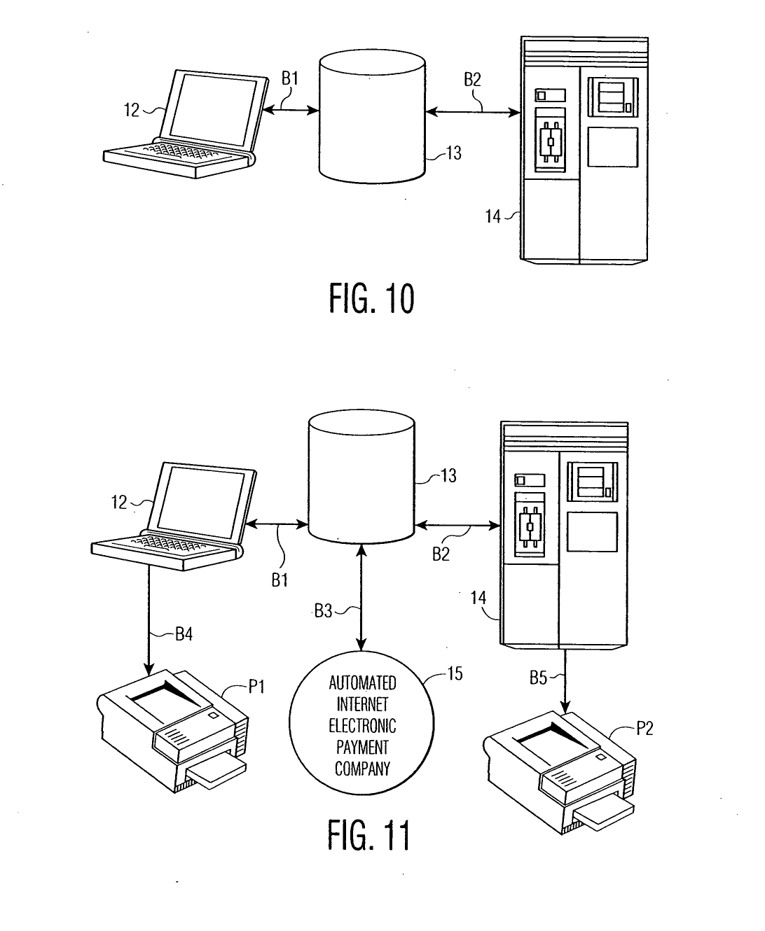

FIG. 10 is an overview illustrating a manner in which a user may access the present invention. More particularly, FIG. 10 is a graphic illustration of an overview depicting an exemplary manner in which a user may access the present invention via, for example, an Internet Access Device (12). If, in an alternative embodiment, a communication network other than the Internet is used, a different type of access device may be used. Internet Access Device (12) may any one of many known Internet access devices or appliances. Exemplary access devices may be Microsoft Corporation's MSN TV receiver, model number RM2100, manufactured by RCA, Hitachi SH-G1000 Pocket PC Phone Edition 2002 from Sprint PCS, or other Internet connection access devices. Internet Access Devices (12) may be connected to the World Wide Web (13) or other global communication network via an Internet Connection or other Connection (B1) that may be one of many known forms such as a telephone hardwired modem, a cable TV, DSL, T1, T2, T3, wireless modem, satellite, or other available Internet connection.

In one exemplary embodiment, the invention may also use a Server (14). The invention's Server (14) may be connected to World Wide Web (13) or to another global communication network via an Internet Connection or other connection (B2). Internet Connection may be one of many known forms such as a telephone hardwired modem, cable TV, DSL, T1, T2, T3, wireless modem, satellite, or other available Internet or other connection.

A store or other seller of animals, may determine who may have access to information about an animal and the scope of such access when the store or other seller enters certain information into the system. The information that the store or seller may enter is, for example, a microchip number specific to the animal, the name and location of a breeder, the name and location of a distributor, and store identification number. The system may allow a breeder to have total access to his own records. The system may allow a Current Owner to have total access to his own records and preclude access to records after the animal is transferred to a new owner. The system may allow a Veterinarian to have total access to his own records and total access to all records pertaining to any animal the veterinarian has treated. As used herein, total access is defined as being able to view and enter data into the respective records of an animal that the Veterinarian is caring for.

The system may allow each authorized user real-time, fully secure access to information in the system about an animal. The system may only allow predetermined users and computers access to the system.

FIG. 11 is an overview illustrating a manner in which a user may access the present invention coupled to an automated electronic payment processing company or system. More particularly, FIG. 11 is an exemplary graphic illustration of an overview depicting the manner in which a user may access the present invention via the Internet Access Device (12). Internet Access Device (12) may be any one of many known Internet access devises such as Microsoft Corporation's MSN TV receiver, model number RM2100, manufactured by RCA, or Hitachi SH-G1000 Pocket PC Phone Edition 2002 from Sprint PCS, and Internet connection access devises. Internet Access Device (12) may be connected to the World Wide Web (13) via Internet Connection (B1) that may be any one of many known forms such as a telephone hardwired modem, a cable TV, DSL, T1, T2, T3, wireless modem, satellite, or other available Internet connection.

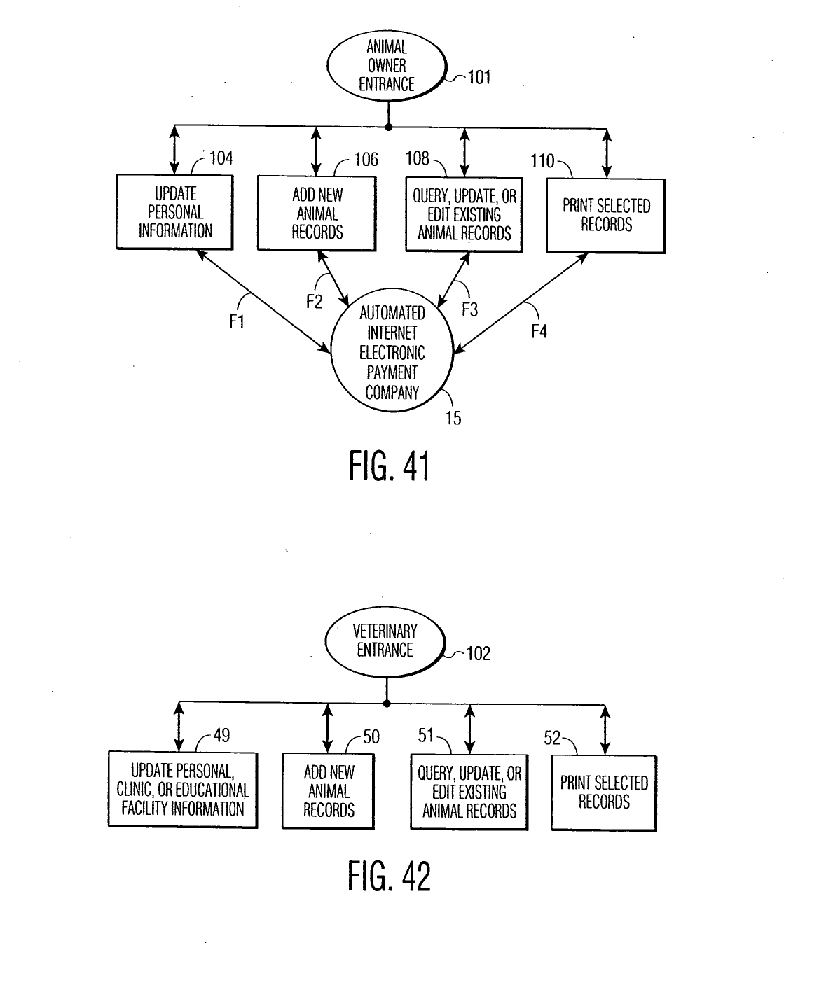

The invention's Internet Server (14) may be connected to World Wide Web (13) via Internet Connection (B2). Internet Connection (B2) may be any one of many known forms such as a telephone hardwired modem, a cable TV, DSL, T1, T2, T3, wireless modem, satellite, or other available Internet connection. An exemplary embodiment of the invention may also use an Automated Internet Electronic Payment Company (15), which may allow for paperless, electronic, and unmanned payment to the company that hosts the Internet Server (14) for services that may be performed by the company. Examples of services that may be performed by the host company are transfer of ownership, medical record update, animal identification update, filing of government forms and records, production and reproduction of ownership certificates and pedigree certificates, production of medical record history, printing of prepaid coupons, litter records, and offspring registration applications. A screen may be displayed to connect to Automated Internet Electronic Payment Company (15) when a user wants a host company to perform services for the user. Automated Internet Electronic Payment Company (15) may utilize an Internet Connection (B3) comprised of any one of many known forms of Internet access forms such as a telephone hardwired modem, cable TV, DSL, T1, T2, T3, wireless modem, satellite, or other available Internet connection. Internet Connection (B3) may connect the Automated Internet Electronic Payment Company (15) to the Internet Access Device (12) and to the Internet Server (14). Automated Internet Electronic Payment Company (15) may also be used in connection with those aspects of an exemplary embodiment of the invention illustrated in FIGS. 41, 43, and 45 and described below.

A user may also have an option of using printing capabilities. An exemplary embodiment of a user's optional printing capabilities is illustrated in FIG. 11, where Internet Access Device (12) is shown as being connected to Printer (P1) via a Printer Connection (B4). Printer Connection (B4) may be comprised of any one of many known forms of printer connections such as a parallel port cable, a serial cable, a fire-wire cable, a LAN CAT-5 cable, a wireless broadband router signal, or other available printer connection. Similarly, a company hosting the Internet Server (14) may also have optional printing capabilities as illustrated in FIG. 11. As shown in FIG. 11, Internet Server (14) may be connected to a Printer (P2) via a Printer Connection (B5). Printer Connection (B5) may be comprised of any one of many known forms of printer connections such as a parallel port cable, a serial cable, a fire-wire cable, a LAN CAT-5 cable, a wireless broadband router signal, or other available printer connection. For example a hosting company or a store may use Printer (P1) or Printer (P2) to print prepaid stickers which a customer may later use to pay for services and products.

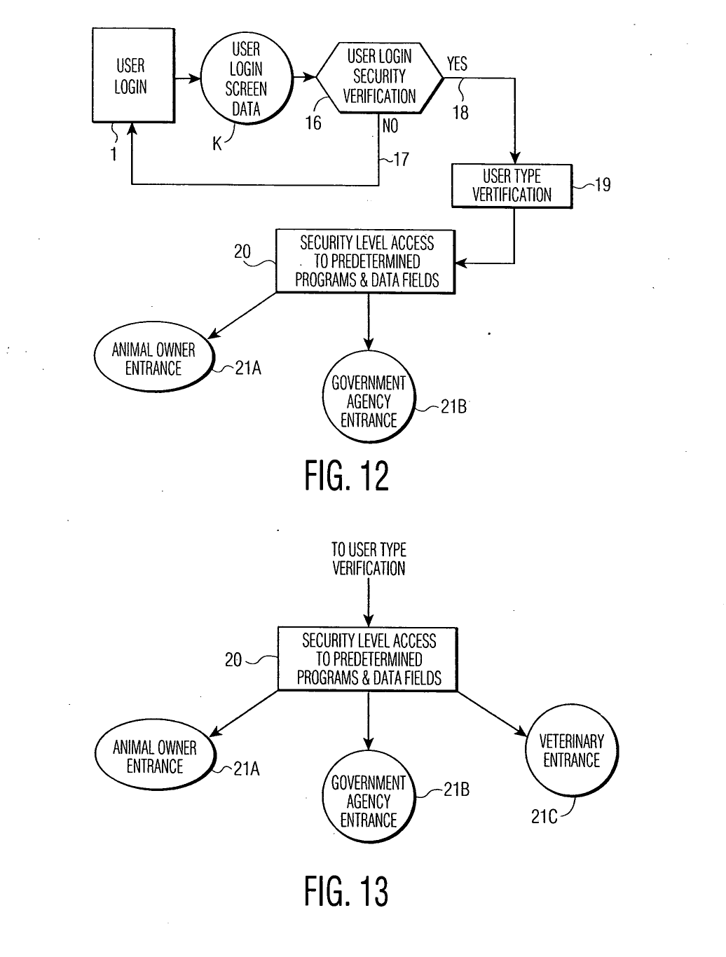

FIG. 12 is an exemplary flow diagram illustrating a User Login screen's security logic features coupled with an ability to sort and direct users to predetermined security levels and applications in accordance with an exemplary embodiment of the present invention. More particularly, FIG. 12 illustrates a logic flow of part of an exemplary embodiment of the present invention's method. In FIG. 12, data shown in Screen Shot 1A is identified as User Login Screen Data (K). Referring to FIG. 12, after there is User Login (1), User Login Screen Data (K) may be transmitted to a User Login Security Verification (16). In Decision Block 16, the invention determines if the User Login Screen Data (K) matches predetermined data that is stored on Internet Server (14). If there is a match, as illustrated by Yes (18), User Login Security Verification (16) queries Internet Server (14) for User Type Verification (19). User Type Verification (19) allows the present invention to direct the user to a predetermined computer application that is stored on Internet Server (14). A number of predetermined computer applications may be stored on Internet Server (14) that are specific for the needs of different classifications of users. These applications are illustrated by Security Level Access To Predetermined Data Fields (20). Illustrations of examples of two such user types are shown in FIGS. 12 and 13 as an Animal Owner Entrance (21A) and Government Agency Entrance (21B), respectively.

Alternatively, if the User Login Screen Data (K) does not match the predetermined data stored on Internet Server (14), the answer to Decision Block 16 would be No (17). Under that condition, the user would be prohibited from electronically entering the Internet Based Server (14) and would be routed back to the original User Login (1).

FIG. 13 is an exemplary flow diagram illustrating an ability to sort and direct users to predetermined security levels and applications in accordance with an exemplary embodiment of the present invention. More particularly, FIG. 13 shows an exemplary flow chart of an exemplary logic method for coupling different kinds of users to the invention's system. In this exemplary illustration, Security Level Access To Predetermined Programs & Data Fields (20) illustrates three exemplary user type entrances: an Animal Owner Entrance (21A), a Government Agency Entrance (21B), and a Veterinary Entrance (21C). That is, the system may be accessed by the authorized owner of an animal, by an authorized government agency, or by an authorized veterinary user. In other exemplary embodiments, other types or classes of users may also be authorized to access the system.

It will be understood that the system components and the people who use the system may be located in different parts of the world. For example, and for illustration purposes only, Animal Owner Entrance (21A) may be in a country other than the United States, Government Agency Entrance (21B) may be in Texas in the United States, Veterinary Entrance (21C) may be in New Jersey in the United States, and Internet Server (14) may be in Pennsylvania in the United States. It will also be understood that all of these components and people who use the system may be located in the same State and Country.

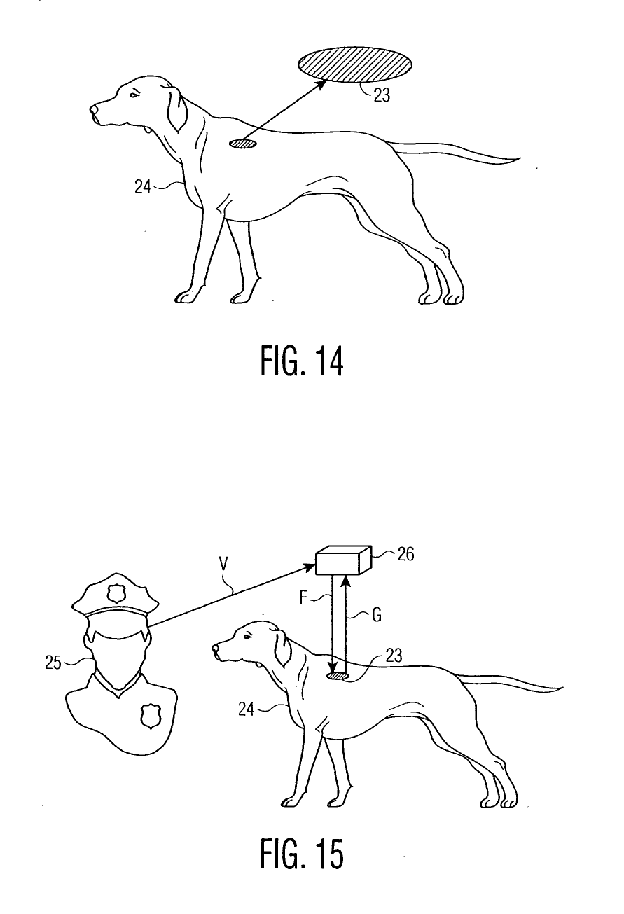

FIG. 14 is a graphic representation of an animal that carries a microchip used for unique identification. More particularly, FIG. 14 is a graphic representation illustrating an exemplary use of a Microchip (23) that is affixed on, in, or under the skin of an Animal 24. The broad use of microchips in animals is well known and is thus not further described herein. Microchips can be obtained through most veterinary supply companies and are manufactured by companies such as AVID Identification Systems, Inc. of Folsom, La.

FIG. 15 is a graphic representation of an exemplary method showing how a government representative may acquire the microchip identification number of an animal using a universal or other microchip scanner. More particularly, FIG. 15 is a graphic representation illustrating how a Government Representative (25) may utilize a Microchip Scanner (26) to transmit a Signal (F) to energize Microchip (23). In an exemplary embodiment, Government Representative (25) may activate or couple Microchip Scanner (26) over a wireless connection (V). The wireless connection may be implemented over a Global Information Network such as the Internet. Once energized, Microchip (23) may emit a separate signal (G) that may be received and displayed by Microchip Scanner (26). Microchip Scanner (26) may be a transceiver. An example of Microchip Scanner (26) is Model Power Tracker II, manufactured by AVID Identification Systems, Inc. of Folsom, La. Once obtained, the microchip information may be provided by Government Representative (25) to the exemplary system and information pertaining to animal 24 may then be accessed by Government Representative (25). This information may include for example, owner information, animal medical history, etc.

Although microchip identification is described above the invention is not so limited in that other means may be used to identify a particular animal, such as the below non-limiting illustrated examples.

FIG. 16 is a graphic representation of an animal that has an illustrative tattoo that may be used for unique identification. More specifically, FIG. 16 is an illustration of an exemplary embodiment of how the present invention may use a unique Tattoo Identification Number (27) that may be permanently embedded into the skin of Animal (24).

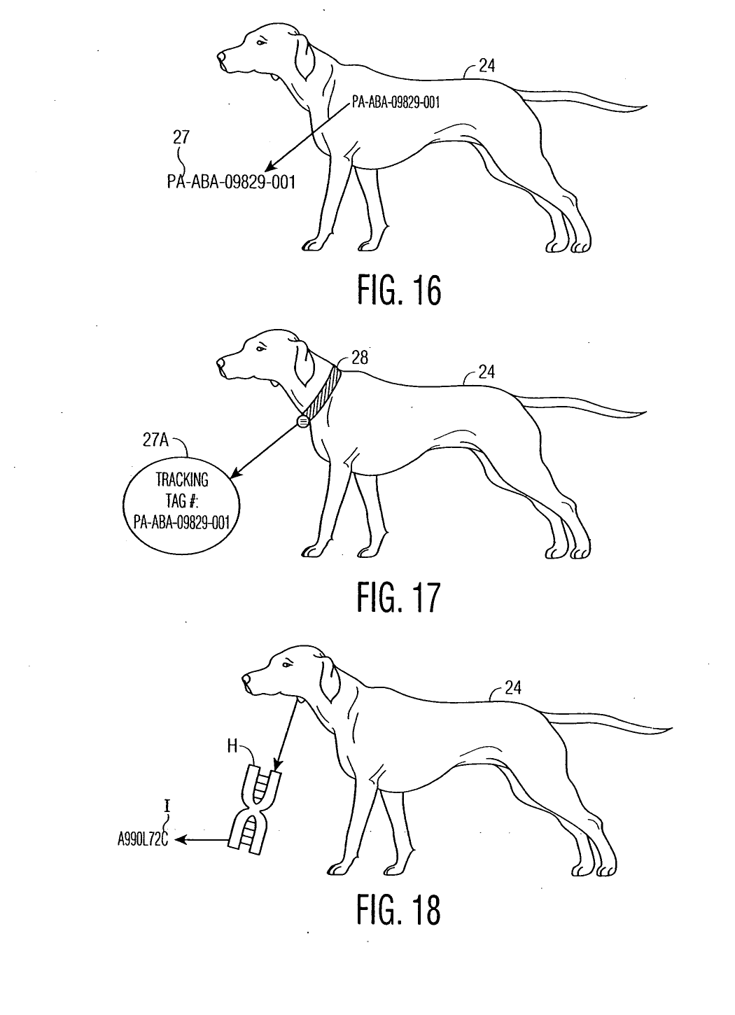

FIG. 17 is a graphic representation of an animal that has a tag attached to its collar for unique identification. More specifically, FIG. 17 is an illustration of an exemplary embodiment of how an exemplary embodiment of the present invention may use a unique Identification Tag (27A) that may be affixed to Animal (24) via a Collar (28).

FIG. 18 is a graphic representation of an animal's DNA sample used for unique identification. More specifically, FIG. 18 is an illustration of an exemplary embodiment of how an exemplary embodiment of the present invention may use a unique DNA Identification Tracking Number (I) issued by a DNA testing company such as HealthGene Molecular Diagnostic and Reasearch Center, 2175 Keele St., Toronto, ON, Canada M6M 3Z4 after a DNA Sample (H) has been obtained from Animal (24).

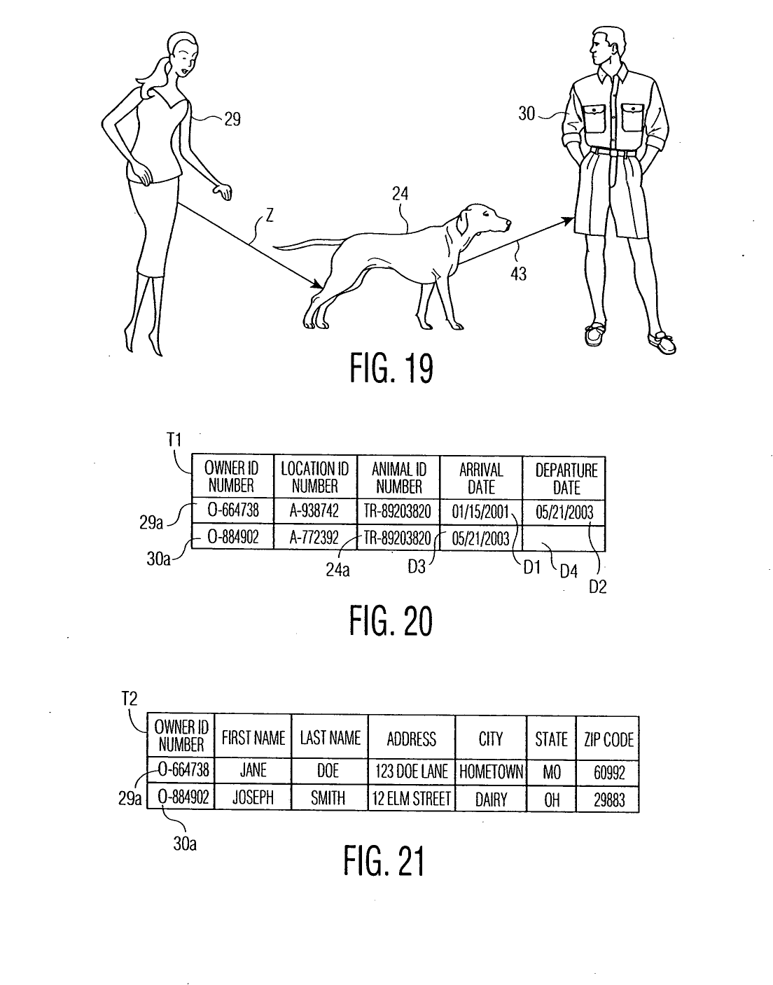

Referring now to FIG. 19, a graphic representation of a transfer of ownership of an animal is illustrated. More specifically, FIG. 19 is a graphic representation of Original Animal Owner (29) transferring ownership of Animal (24) to Current Animal Owner (30). It will be understood that reference number (29) may also refer to a Previous Owner. It will also be understood that reference number (30) may also refer to a New Owner. There may be only one Original Owner; but there may be more than one Previous Owner. Similarly, there may be more than one New Owner; but there may be only one Current Owner. It will also be understood that FIG. 19 may illustrate other transfers of an animal. For example, it may illustrate the transfer of an animal by a broker from one kennel to another kennel.

The present invention's computer system utilizes a database of multiple indexed tables. This use of indexed tables allows for a significant reduction in the overall size of the database and a greatly enhanced operating and computing speed. Each indexed table may store a respective datum about an animal and all people and entities who contact the animal. FIG. 20 is an illustration of an indexed ownership table of an animal that may be used in accordance with an exemplary embodiment of the present invention. More specifically, FIG. 20 is an illustration of an Indexed Ownership Table (T1). In Indexed Ownership Table (T1), illustrative Owner ID Number (29a) represents a unique identification number that may be used to identify Original Animal Owner (29). Likewise, illustrative Owner ID Number (30a) represents a unique identification number that may be used to identify Current Animal Owner (30). Illustrative Animal ID Number (24a) represents a unique identification number that may be used to identify Animal (24).

Illustrative Arrival Date (D1) in FIG. 20 illustrates a date that may be stored in the invention's database to record the beginning date when Original Owner (29) commenced ownership of Animal (24). Illustrative Departure Date (D2) illustrates a date that may be stored in the invention's database to record the ending date when Original Owner (29) ceased ownership of Animal (24). Illustrative Arrival Date (D3) illustrates a date that may be stored in the invention's database to record the beginning date when Current Owner (30) commenced ownership of Animal (24). In the illustrative table shown in FIG. 20, illustrative date D2 is the same as illustrative date D3. However, dates D2 and D3 need not be the same date. A Departure Date (D4) illustrates a date that may be stored in the invention's database to record the ending date when Current Owner (30) ceased ownership of Animal (24). In FIG. 20, Departure Date (D4) field is empty illustrating that Current Owner (30) still owns Animal (24). A departure date as listed in table T1 without a subsequent Arrival Date may be indicative of the animal's death or other loss. In an alternative embodiment of FIG. 20, dates may be entered when someone other than an Owner possesses an animal.

Information may be entered into Indexed Ownership Table (T1) by an Original Owner (29) and by a Current Owner (30). When Current Owner purchases an animal, Current Owner becomes Original Owner, etc. Once an Owner (whether an Original Owner or a Current Owner) enters a Departure Date for an animal, the Owner who enters the Departure Date is precluded by the system from editing records pertaining to that animal and is precluded from retrieving new information about the animal that is entered into the system after the entry of the Departure Date information. The transferring Owner gives the New Owner a new internet access number. The New Owner may then confirm the Old Owner's departure information using the new internet access number.

FIG. 21 is an illustration of an indexed owner's address table in accordance with an exemplary embodiment of the present invention. More specifically, FIG. 21 illustrates that an exemplary embodiment of the invention's database may record a physical home address of an owner even though the owner's physical address may be different than the animal's physical address. Table (T2) accordingly is another example of an indexed table that may be used as part of the invention. Illustrative Animal Owner's Address Table (T2) may index and link the name and home address of an Original Animal Owner (29) with an Original Animal Owner ID Number (29a). Likewise, the name and address of a Current Animal Owner (30) may be indexed and linked to a Current Animal Owner ID Number (30a). In exemplary Table (T2), the first and last names of Original Animal Owner (29) are identified as Jane Doe; the address of Original Owner 29 is identified as 123 Doe Lane, Hometown, Mo. 60992. Exemplary Table (T2) identifies the first and last names of Current Animal Owner (30) as Joseph Smith; the address of Current Animal Owner (30) is identified as 12 Elm Street, Dairy, Ohio 29883. In an alternative embodiment, FIG. 21 may identify the names and addresses of people other than an Owner who may possess an animal.

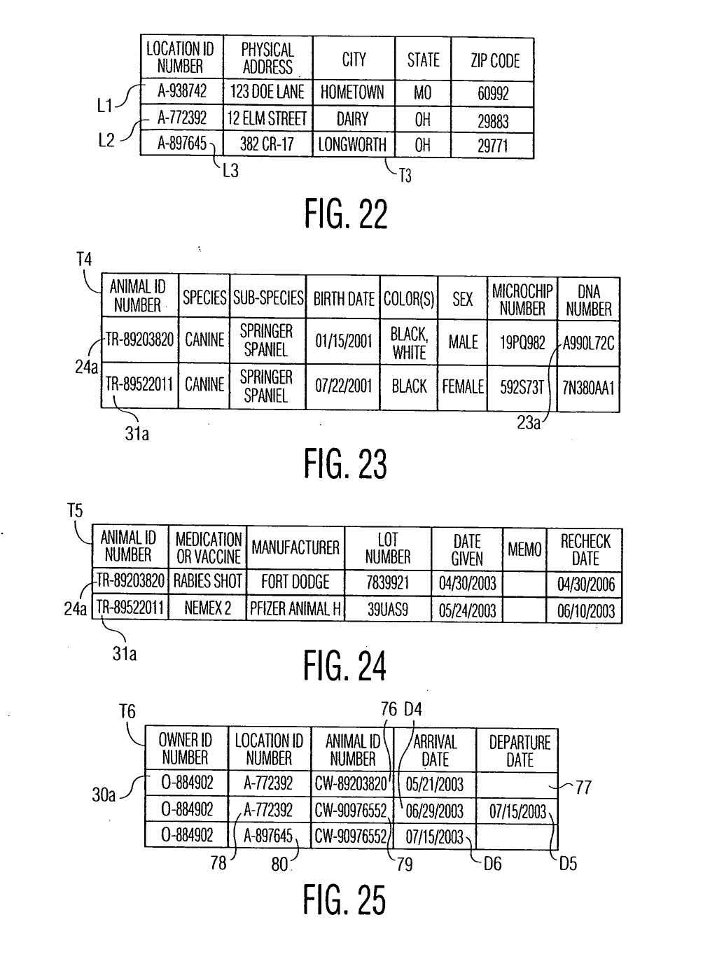

FIG. 22 is an illustration of an indexed facility location address table in accordance with an exemplary embodiment of the present invention. More specifically, FIG. 22 illustrates that the invention's database may record an animal's physical address if it is the same as the animal owner's home or other address or if it is different than the animal owner's home or other address. Animal's Physical Address Table (T3) is another example of an indexed table. Animal's Physical Address Table (T3) allows for the input of one or more physical location sites of Animal (24). Location ID Number (L1), Location ID Number (L2), and Location ID Number (L3) are all examples of different location sites that may be indexed within an exemplary embodiment of the present invention's computer system. In addition to each Location ID Number Table T3 may also include the physical address, city, state, and zip code associated with each Location ID Number.

FIG. 23 is an illustration of an indexed identification table of an animal in accordance with an exemplary embodiment of the present invention. More specifically, FIG. 23 illustrates that the invention's database may store an animal's species, sub-Species, Birth Date, color(s) Sex, Microchip Number (23a), DNA Number, and other information of the animal that a user of the system wishes to enter in the animal's record. Animal Information Table (T4) is an example of data that may be associated with Animal ID Number (24a) and Animal ID Number (31a). For example, Animal Information Table (T4) illustrates that an animal with illustrative Animal ID Number TR-89203820 may be a black, white male canine, Springer Spaniel, having an illustrative birth date of Jan. 15, 2001. It has been assigned an illustrative Microchip Number 19PQ982 and an illustrative DNA Number A990L72C. Similarly, Animal Information Table (T4) illustrates that the animal with illustrative Animal ID Number TR-89522011 may be a black female canine, Springer Spaniel, having an illustrative birth date of Jul. 22, 2001. It has been assigned an illustrative Microchip Number 592S73T and an illustrative DNA Number 7N380AA1.

FIG. 24 is an illustration of an indexed veterinary health record table of an animal in accordance with an exemplary embodiment of the present invention. More specifically, FIG. 24 illustrates that the invention's database may store an animal's medical data such as medications or vaccines that have been administered to the animal and other information about the medication or vaccine including information such as the manufacturer of the medication or vaccine, the lot number, the date it was given to the animal, the date when the animal should be rechecked for possible re-medication or re-vaccination, and other information of the animal that the user of the system wishes to enter in the animal's record. Illustrative Medical Record Table (T5) is an illustration of medical data that may be associated with illustrative Animal ID Number (24a) and illustrative Animal ID Number (31a). As an illustration, FIG. 24 shows that the animal with Animal ID Number TR-89203820 had a rabies shot on Apr. 30, 2003. The rabies vaccine was manufactured by Fort Dodge and was from Lot Number 7839921. The animal is to be rechecked on Apr. 30, 2006. As another illustration, FIG. 24 shows that the animal with illustrative Animal ID Number TR-89522011 was given Nemex 2 medication on May 24, 2003. The medication was manufactured by Pfizer Animal H and was from Lot Number 39UAS9. The animal is to be rechecked on Jun. 10, 2003. Although no information is contained in either “Memo” column, additional medical information may be placed there, as desired.

FIG. 25 is an illustration of an indexed animal owner table that may be used to show multiple animals owned at different locations in accordance with an exemplary embodiment of the present invention. More specifically, FIG. 25 illustrates that the invention's database may store information about all of the animals that may be owned by a single user at multiple transfer locations. Owner/Animal/Location Table (T6) illustrates that the owner assigned to illustrative Owner ID Number (30a) O-884902 has recorded into the invention's database two separate locations areas. The invention's database may create and store a unique indexed Location ID Number for each location as represented by Location ID Number (78) and Location ID Number (80).

Owner/Animal/Location Table (T6) shows the historical and chronological location of animals. For example, illustrative Animal ID Number (79) arrived at Location ID Number (78) on illustrative Arrival Date (D4) and was subsequently transferred by illustrative Owner ID Number (30a) on illustrative Departure Date (D5), creating an illustrative Arrival Date (D6) at illustrative Location ID Number (80). In the example illustrated in FIG. 25, Arrival Date (D6) is the same date as Departure Date D5. However, the two dates need not be the same. Owner/Animal/Location Table (T6) also shows location information and other information for another animal identified with illustrative Animal ID Number CW-89203820. In another embodiment, Table (T6) may provide information about any number of animals.

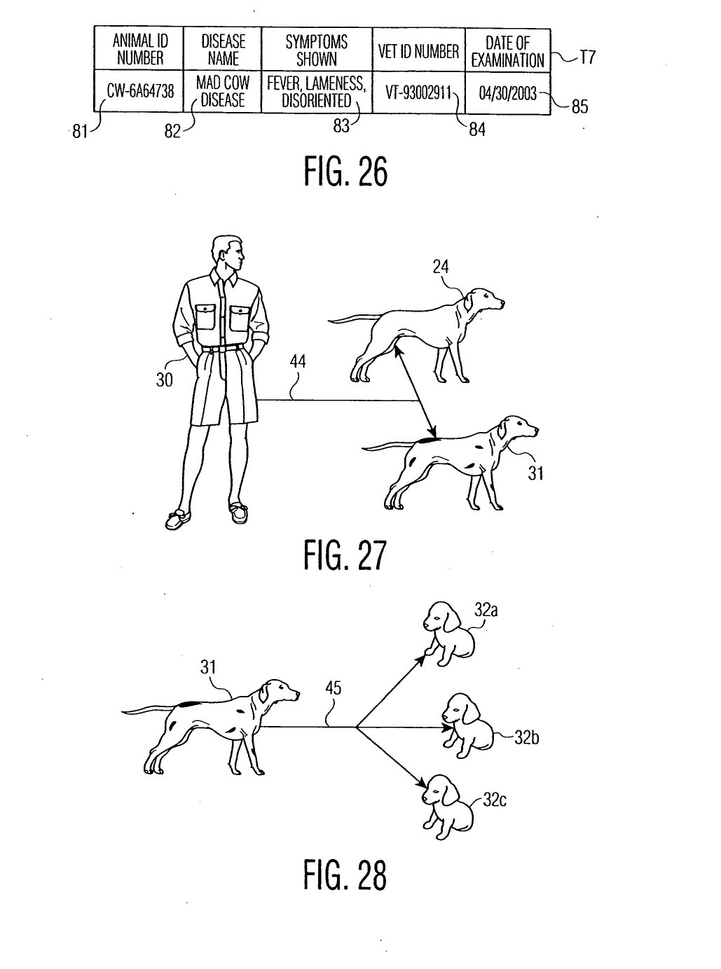

FIG. 26 is an illustration of an indexed contagious disease-tracking table of an animal that may be used in accordance with an exemplary embodiment of the present invention. More specifically, FIG. 26 illustrates that the invention's database may record and track disease information about an animal about which information is contained in the system. Disease Tracking Table (T7) identifies an animal with illustrative assigned Animal ID Number (81) as having illustrative Disease Name (82) with illustrative Symptoms Shown (83). The illustrative Vet ID Number (84) is indexed to the veterinarian, clinic, or educational facility that has diagnosed the animal's disease on illustrative Date of Examination (85).

After information is entered into the system and tables are created, a user may track information about an animal by searching the system's database. For example, by entering an animal's microchip number, a user may determine the name, breed, whelping date, sex, colors and owner information about the animal such as the owner's name, address, and telephone number. Similarly, a veterinarian or a Government Agency may track the health and disease information about an animal.

FIG. 27 is a graphic representation of an owner of an animal initiating the breeding of a male and female to produce offspring. More specifically, FIG. 27 is a graphic representation of an Animal Owner (30) initiating the Breeding (44) of male Animal (24) to female Animal (31) for purposes of procreation.

FIG. 28 is a graphic representation of a female animal producing offspring after being bred. More specifically, FIG. 28 is a graphic representation of female Animal (31) subsequently Giving Birth (45) to Offspring (32a), Offspring (32b), and Offspring (32c). This number of offspring many range from one to the maximum number any one female species of animal may produce.

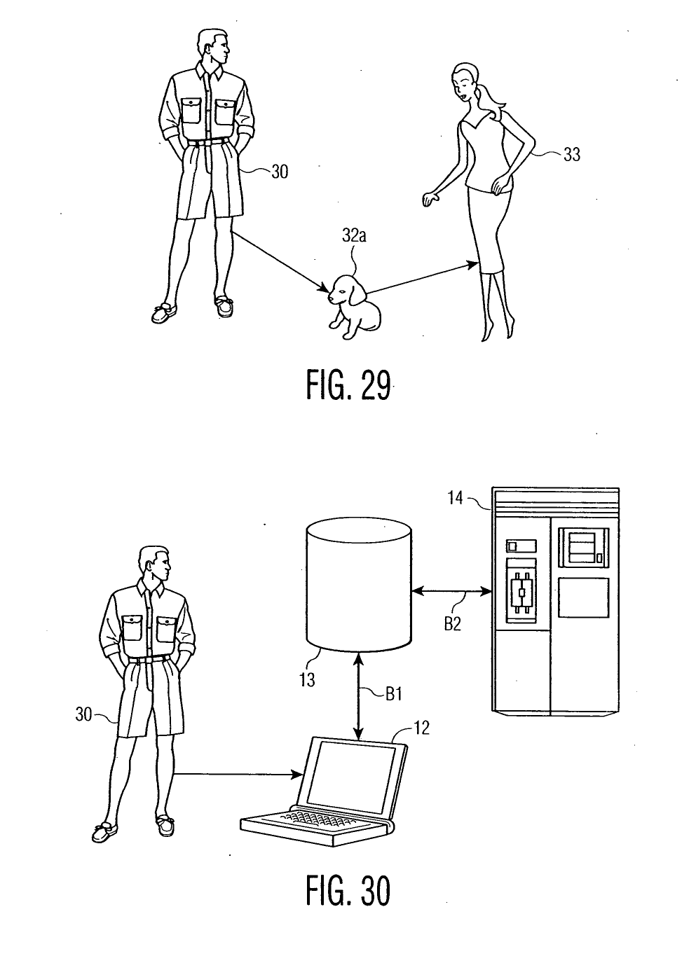

FIG. 29 is a graphic representation of a transfer of ownership of an animal's offspring to a new owner. More specifically, FIG. 29 is a graphic representation of Animal Owner (30) transferring ownership of Offspring (32a) to Offspring Owner (33).

FIG. 30 is a graphic overview flow chart illustrating a manner in which an animal's owner who is a breeder may use the present invention. More specifically, FIG. 30 is an overview illustrating the manner in which Animal Owner (30) who is a breeder may use the present invention. As shown in FIG. 30, Animal Owner (30) may utilize Access Device (12) to access World Wide Web (13) via Internet Connection (B1). World Wide Web (13) may be connected to Internet Server (14) via Internet Connection (B2). By placing information into tables such as Tables (T1) to (T7), Animal Owner (30) may record breeding information, offspring birth information, medical information, microchip numbers, tattoo numbers, ownership transfer information, and other information about animals that are owned by Animal Owner (30).

FIG. 31 is a graphic overview illustrating a manner in which a new owner of offspring from an animal may use an exemplary embodiment of the present invention. More specifically, FIG. 31 is an overview illustrating the manner in which Offspring Owner (33) who is a new owner of an animal may use the present invention. Offspring Owner (33) may utilize Access Device (12) to access World Wide Web (13) via Internet Connection (B1). World Wide Web (13) may be connected to Internet Server (14) via Internet Connection (B2). By placing information into tables such as Tables (T1) to (T7), Offspring Owner (33) may record animal information, ownership transfer information, and other information about animals that are owned by Offspring Owner (33).

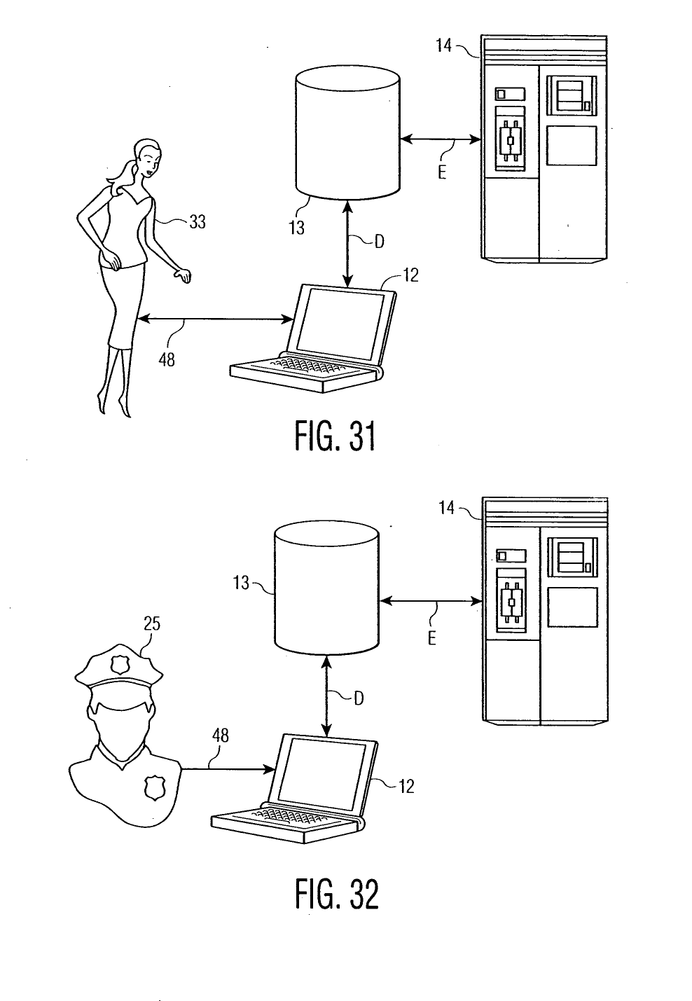

FIG. 32 is a graphic overview illustrating a manner in which a government representative may use an exemplary embodiment of the present invention. More specifically, FIG. 32 is an overview illustrating the manner in which a Government Representative (25) may use the present invention. Government Representative (25) may utilize Access Device (12) to access World Wide Web (13) via Internet Connection (B1). World Wide Web (13) may be connected to Internet Server (14) via Internet Connection (B2). The procedures described above allow Government Representative (25) to have ready access to predetermined records and data fields pertaining to animals whose data has been recorded in the system. The information be used to verify compliance with regulatory laws such as state or federal inspections required by the Department of Agriculture or to identify a lost or stolen animal. The system may allow a Government Representative to review a specific number of records with a specific period of time. The system may track a Government Representative's access to records in the system. If a Government Representative accesses a predetermined number of records within a predetermined period of time, the system may prevent that Government Representative from accessing additional records. The purpose of the prevention feature of the system is to protect against the possibility that an unauthorized person might break into the system using a Government's Representative's access information.

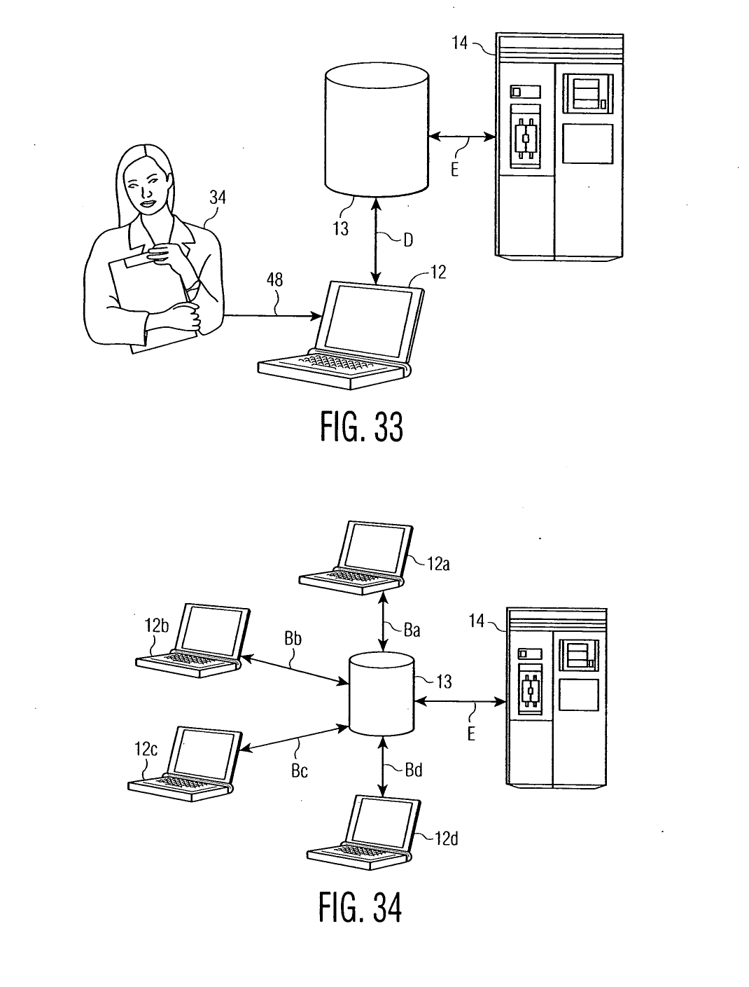

FIG. 33 is a graphic overview illustrating a manner in which a veterinarian may use an exemplary embodiment of the present invention. More specifically, FIG. 33 is an overview illustrating the manner in which a Veterinary Representative (34) may use the present invention. Veterinary Representative (34) may utilize Access Device (12) to access World Wide Web (13) via Internet Connection (B1). World Wide Web (13) may be connected to Internet Server (14) via Internet Connection (B2). The procedures and tables described above may allow Veterinary Representative (34) to have ready access to predetermined records and data fields of animals about which information is stored in the system's database. The stored information may be used, for example, for updating veterinary health records, or in conjunction with government agencies to determine the source of diseased or infected animals and to determine if they have had contact with other animals or animal colonies. The system may allow a veterinarian to review a specific number of records with a specific period of time. The system may track a veterinarian's access to records in the system. If a veterinarian accesses a predetermined number of records within a predetermined period of time, the system may prevent that veterinarian from accessing additional records. The purpose of the prevention feature of the system is to protect against the possibility that an unauthorized person might break into the system using a veterinarian's access information.

FIG. 34 is a graphic overview illustrating a manner in which multiple users may access an exemplary embodiment of the present invention. More specifically, FIG. 34 is an overview illustrating the manner in which multiple access devices may simultaneously access the present invention. Internet Access Device (12a) may access World Wide Web (13) via Internet Connection (Ba). Internet Access Device (12b) may access World Wide Web (13) via Internet Connection (Bb). Internet Access Device (12c) may access World Wide Web (13) via Internet Connection (Bc). Internet Access Device (12d) may access World Wide Web (13) via Internet Connection (Bd). World Wide Web (13) may connect Server (14) via Internet Connection (E) to some or all of the Internet Access Devices.

FIG. 34 illustrates that multiple authorized users may access information in an exemplary embodiment of the present invention about the same animal simultaneously. FIG. 34 illustrates, for example, that authorized private individuals, authorized corporations, authorized veterinarians, and authorized government representatives may all be able to access the same information about the same animal simultaneously. However, the system may limit the information that is available to each of them. That is, the system may grant each of them a different level of access. For example, a government representative may have access to a first scope of information in order to conduct a government audit, for example, to track mad cow disease. A farmer may have a different, more limited, scope of access to information that may enable the farmer to identify his cattle. A store, or other distributor may have still another limited scope of access to information that may enable the store or other distributor to retrieve breeding and health information about animals at the store or other distributor that are available for sale.

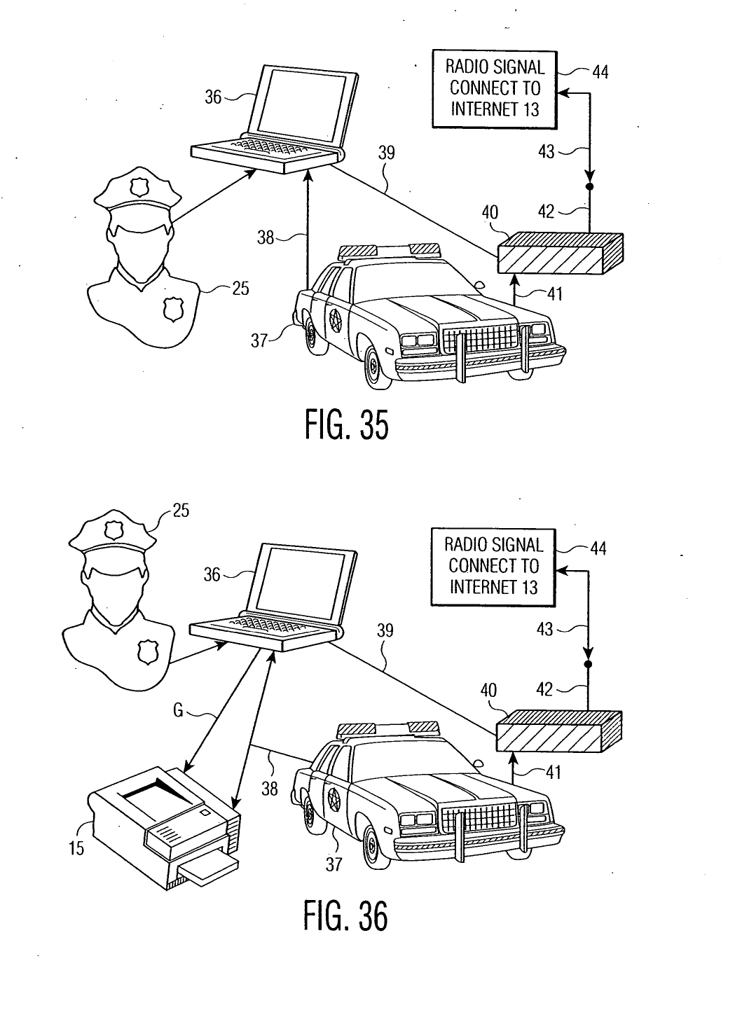

FIG. 35 is a graphic exemplary overview illustrating a manner in which a government representative may use a wireless mobile method to access predetermined computer programs, processes, and data fields of an exemplary embodiment of the present invention. More specifically, FIG. 35 is a graphic exemplary overview illustrating the manner in which a government representative may utilize a wireless, mobile connection with an exemplary embodiment of the present invention. Government Representative (25) may access the present invention via Mobile Internet Access Terminal (36). In an exemplary embodiment, Mobile Internet Access Terminal (36) may be powered by an electrical system of vehicle (37) via a Power Connection (38). In an alternative embodiment, Mobile Internet Access Terminal (36) may be powered by another source of power. Wireless Modem (40) may powered by an electrical system of Vehicle (37) via Power Connection (41). In an alternative embodiment, Wireless Modem (40) may be powered by another source of power. Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that may be connected to World Wide Web (13).

FIG. 36 is a graphic exemplary overview illustrating a manner in which a government representative may use a wireless mobile method to access predetermined computer programs and data fields coupled with a printer of an exemplary embodiment of the present invention. More specifically, FIG. 36 is a graphic exemplary overview illustrating the manner in which a government representative may utilize a wireless mobile use of the present invention. Government Representative (25) may access the present invention via Mobile Internet Access Terminal (36). In an exemplary embodiment, Mobile Internet Access Terminal (36) may be powered by the electrical system of Vehicle (37) via Power Connection (38). Also in an exemplary embodiment, Wireless Modem (40) may be powered by the electrical system of Vehicle (37) via Power Connection (41). In an alternative embodiment, Mobile Internet Access Terminal (36) and/or Wireless Modem (40) may be powered by at least one different source of power. Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that is connected to World Wide Web (13). Additionally, Printer (15) may be powered by Power Connection (38) and receive data for printing forms and documents from Mobile Internet Access Terminal (36).

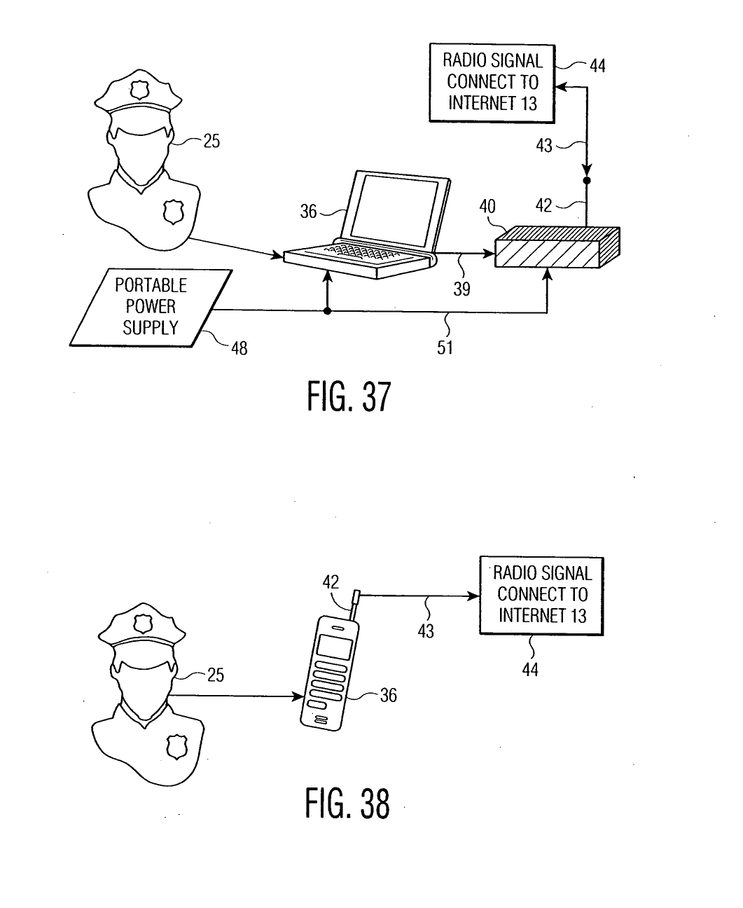

FIG. 37 is a graphic exemplary overview illustrating a manner in which a government representative may use a wireless mobile method to access predetermined processes and data fields coupled with a portable battery supply or other power supply of an exemplary embodiment of the present invention. More specifically, FIG. 37 is a graphic exemplary overview illustrating the manner in which a government representative may utilize a more portable wireless mobile use of the present invention. Government Representative (25) may access the present invention via Mobile Internet Access Terminal (36). Mobile Internet Access Terminal (36) and Wireless Modem (40) may be powered by Portable Power Supply (48) via Power Connection (51). Mobile Internet Access Terminal (36) may utilize Connection (39) to transmit and receive data from Wireless Modem (40). Wireless Modem (40) may utilize Antenna (42) to receive and transmit Signal (43) to Internet Antenna Transceiver (44) that may be connected to World Wide Web (13).

FIG. 38 is a graphic exemplary overview illustrating a manner in which a government representative may use a wireless mobile method to access predetermined processes and data fields of an exemplary embodiment of the present invention. More specifically, FIG. 38 is a graphic exemplary overview illustrating the manner in which a government representative may utilize a highly portable and lightweight wireless mobile use of the present invention. Government Representative (25) may access the present invention via Mobile Internet Access Terminal (36). Said Mobile Internet Access Terminal (36) may be a PDA or cell phone such as the Hitachi SH-G1000 Pocket PC Phone Edition 2002 from Sprint PCS. Wireless Modem (40) may be powered by Portable Power Supply (48) via Power Connection (51). Mobile Internet Access Terminal (36) may utilize Antenna (42) to receive and transmit Signal (43) to Internet Antenna Transceiver (44) that may be connected to World Wide Web (13).

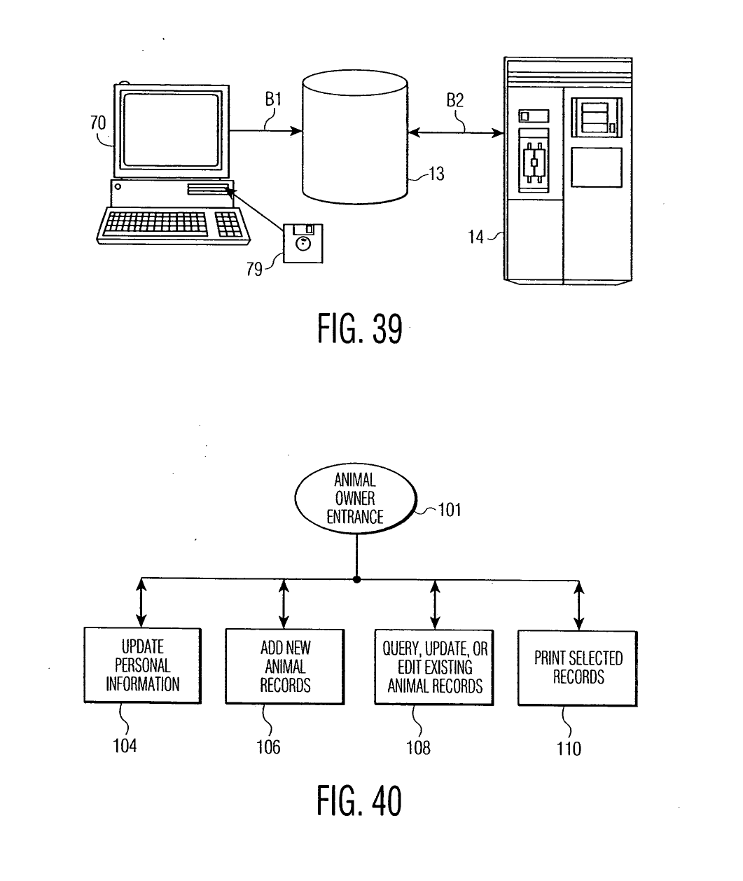

FIG. 39 is a graphic exemplary overview illustrating how an exemplary embodiment of the present invention may be coupled to a user data storage device allowing a user to store a copy of the user's data at the user's location. More specifically, FIG. 39 is a graphic exemplary overview illustrating how the present invention may be coupled to a user data storage device allowing the user to store a copy of the user's data at the user's location. Data stored on Server (14) may be downloaded via Internet Connection (B2) through World Wide Web (13). Internet Access Device (70) may utilize Internet Connection (B1) to complete the download process for storage into a medium such as a Diskette (79). Additional well known storage media may also include, but not be limited, to a burnable CD, a computer hard drive, or a flash memory such as the Viking Flash Memory 128 MB Card manufactured by Viking Components, 30200 Avenida de las Banderas, Rancho Santa Margarita, Calif. 92688, USA.

FIG. 40 is a flow diagram illustrating how an animal owner may access and use predetermined, exemplary, functions in accordance with an exemplary embodiment of the present invention. More specifically, FIG. 40 is a flow chart showing Animal Owner Entrance (101) that allows the animal owner user to transfer information and data between different predetermined applications of the present invention. Option (104) allows the user to update personal information such as name, address, phone number, e-mail address, and other information about the user. Option (106) allows the user to add new animal records to the system. Option (108) allows the user to query, update, or edit existing animal records. Option (110) allows the user to print selected records such as required government forms, medical records, bills of sale, and other historical information maintained in the database of the system.

FIG. 50 is a flow diagram illustrating exemplary information that may be entered into, stored in, retrieved from, and determined from the system by a user of the system in accordance with an exemplary embodiment of the present invention. The processes illustrated in FIG. 50 may be used by a user who has access to the system; for example, an owner, a breeder, a government representative, a veterinarian, or other authorized users. Option 104 illustrates identifying personal information about the persons who may use the system. Option 106 illustrates identifying information that may be entered into the system about animals that may be registered in the system. Option 108 illustrates other information that may be retrieved from the system. Option 110 illustrates information that may be retrieved from the system via a printed record.

Table 150 illustrates information that the user may enter, store, retrieve, and determine in Option (104). For example, the user may determine or correct information about the current owner, such as name, address, city, state, zip code, home telephone number, work telephone number, cellular telephone number, e-mail address. Using Option (104), the user may also enter, store, retrieve, and determine alternative contact information such as name, address, city, state, zip code, home telephone number, work telephone number, cellular telephone number, and e-mail address. When the user is a current Animal Owner, the current Animal Owner may determine the same information about all prior owners of the animal.

Table 152 illustrates information that a user, such as a current Animal Owner, may determine from using Option (106). For example, a current Animal Owner may determine the unique identifier assigned to an animal, an internet transfer code, a current location address of an animal, including city, state, zip code, phone number, work telephone number of a person connected to the animal, an e-mail address at the animal's location, and alternate contact information for the animal.

Table 154 illustrates the kind of summary information that a current Animal Owner or other user may obtain by using Option (108). For example, by querying the database, the current Animal Owner or other authorized user may obtain the animal's historical breeding record. An historical breeding record may include such information as the breeding dates and Animal ID Numbers of animals bred to the animal, whether the breeding was performed naturally or artificially, if the breeding was successful, the number and sex of the offspring, the location of the birth or whelping took place. The current Animal Owner or other authorized user may also obtain the animal's historical veterinary record. An historical veterinary record may include such information as the names and addresses of all veterinarians who have examined or treated the animal, the nature of the treatments rendered to the animal, any diseases treated, and any medications prescribed or administered by each veterinarian. The current Animal Owner or other authorized user may also obtain the animal's identification record. This information may include information about unique identification of the animal such as microchip number, tag number, registration number, tattoo number, color and markings, lineage and birth date.

Option (108) may also be used to add a new breeder and distributor to a kennel. It may also be used by a pet store to view reports used by the pet store.

Table 154 also illustrates that the current Animal Owner may add, store, retrieve, and determine location information pertaining to his own ownership. However, the current Animal Owner may not edit certain previously entered information, such as a previous owner's location information. Table 154 also illustrates that the current Animal Owner or other user may determine the location record of the animal. More specifically, this information may include each location, including name and address, where the animal has been located from birth to the date of inquiry. Table 154 also illustrates that the current Owner or other user may determine colony information about an animal. That is, the current Owner or other user may determine the identity of every other animal that was in the same location as the animal in question. The availability of a colony record may allow the current Animal Owner or other user such as a Government Agency to identify potentially infected animals for quarantine. Table 154 may also allow the current Animal Owner or other user to determine a lineage record about the animal. A lineage record may provide information about physical characteristics and medical history of the animal's ancestry. A lineage record differs from a breeding record in that the breeding history includes breeding that may have not resulted in the procreation of offspring.

Table 156 illustrates the kinds of information that may be printed by the current Animal Owner or other user. Table 156 shows that the current Animal Owner or other user may print all of the information that may be determined in Table 154. In addition, the current Animal Owner or other user may also print ownership transfer forms and government agency forms. A store may also use Tables 154 and 156 to retrieve and print reports that may be useful to the store such as sales analysis reports, warranty information, veterinary health certificates, and types of animals for sale. It will be understood that access to Table 156 may be limited by the scope of access granted to the user.

Although the information illustrated in FIG. 50 and Tables 150-156 may be determined by an Animal Owner, it will be understood that the information may also be retrieved and determined, retrieved, and printed by a veterinarian and/or by a government agency. For example, Department of Agriculture forms may be retrieved and printed. Information and flow information illustrated in FIG. 50 may be applied to like options illustrated in FIGS. 41-45 discussed later.

The system may allow a user to dual register a pet with one or more organizations. For example, a pet may be registered with the American Canine Association and with the International Pet Services Corporation. The registrations may include breed, sex, colors, store cost, initial price, sale price, PUP ID number, microchip number, information about tattoos and other markings, information about the sire and dam such as name, registry, registration number, and stud book code, the name of the breeder, distributor, and date acquired. The system may also allow addition of the same information about a litter. The user may also include the owner(s) name, date of commencing ownership, address, telephone number, e-mail address, animal's name. If the name has previously been registered to a different animal, the system may require the user to select another name under which to register the animal. Registration with these entities may be performed online via a global information network, such as the Internet. The user may pay for the registration using prepaid stickers or by using charge information. Table 156 may allow the user to print registration information after it has been accepted by the system.

FIG. 41 is a flow diagram illustrating how an animal owner may access and use predetermined, exemplary, functions of the present invention coupled with an automated electronic payment processing company in accordance with an exemplary embodiment of the present invention. More specifically, FIG. 41 is an exemplary flow chart showing Animal Owner Entrance (101) that allows the user to transfer between different predetermined applications of the present invention coupled with an automated electronic payment processing company. Option (104) allows the user to update personal information such as the name, address, phone number, e-mail address, and other information about the user. Option (104) utilizes Transfer (F1) to transfer information to Automated Internet Electronic Payment Company (15) for payment for services rendered for the user by the system. Option (106) allows the user to add new animal records to the system. Option (106) utilizes Transfer (F2) to transfer information to Automated Internet Electronic Payment Company (15) for payment for services rendered for the user by the system. Option (108) allows the user to query, update, edit existing animal records and utilizes Transfer (F3) to transfer information to Automated Internet Electronic Payment Company (15) for payment for services rendered for the user by the system. Option (110) allows the user to print selected records such as required government forms, medical records, bills of sale, and other historical information maintained by the database of the system and utilizes Transfer (F4) to transfer information to Automated Internet Electronic Payment Company (15) for payment for services rendered for the user by the system.

FIG. 42 is a flow diagram illustrating how a veterinarian may access and use predetermined, exemplary, functions in accordance with an exemplary embodiment of the present invention. More specifically, FIG. 42 is a flow chart showing Veterinary Entrance (102) that may allow the user to transfer between different predetermined applications of the present invention. Option (49) allows the veterinary user or their representative to update veterinarian, personnel, clinic, or institutional information such as name, address, phone number, e-mail address, and other information about the users of the system. Option (50) allows the user to add new animal records to the system. Option (51) allows the user to query, update, or edit existing animal records. Option (52) allows the user to print selected records use as required government forms, medical records, transaction logs, and other historical information maintained by the system.

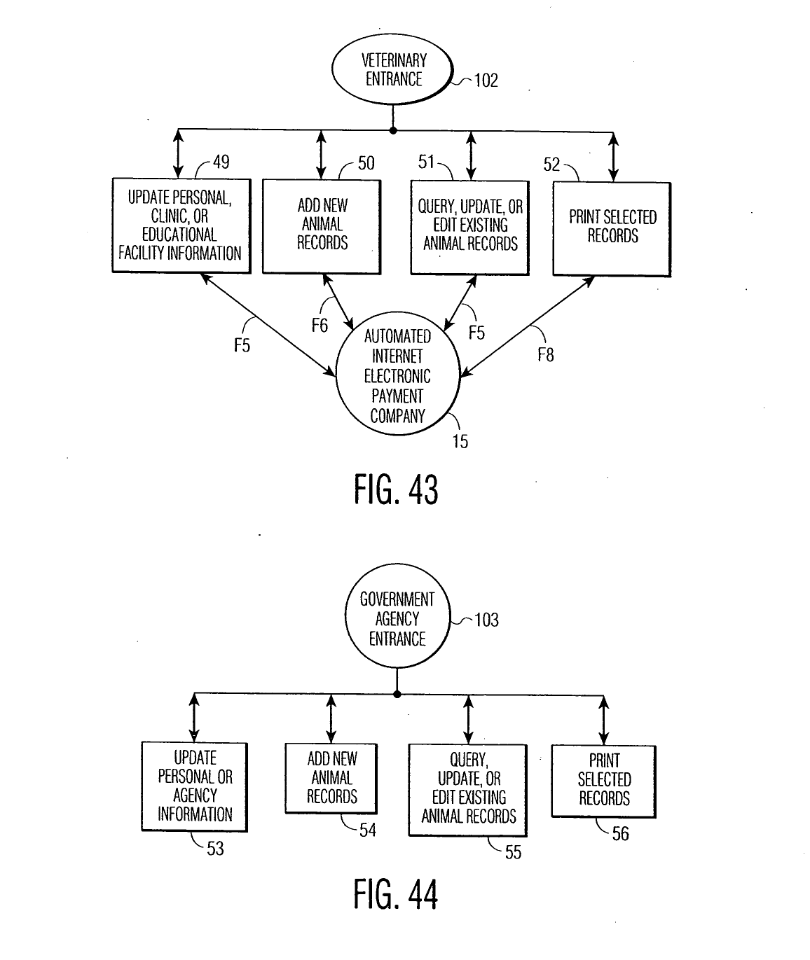

FIG. 43 is a flow diagram illustrating how a veterinarian may access and use predetermined, exemplary, functions in accordance with an exemplary embodiment of the present invention coupled with an automated electronic payment processing company. More specifically, FIG. 43 is an exemplary flow chart showing Veterinary Entrance (102) that allows the user to transfer between different predetermined applications of the present invention coupled with an automated electronic payment processing company. Option (49) allows the veterinary user or their representative to update veterinarian, personnel, clinic, or institutional inform such as name, address, phone number, e-mail address, and other information about the users of the system and utilizes Transfer (F5) to transfer information to Automated Internet Electronic Payment Company (15) for payment for services rendered by the system. Option (50) allows the user to add new animal records to the system and utilizes Transfer (F6) to transfer information to Automated Internet Electronic Payment Company (15) for payment for services rendered by the system. Option (51) allows the user to query, update, or edit existing animal records and utilizes Transfer (F7) to transfer information to Automated Internet Electronic Payment Company (15) for payment for services rendered by the system. Option (52) allows the user to print selected records such as required government forms, medical records, transfer logs, and other historical information maintained by the system and utilizes Transfer (F8) to transfer information to Automated Internet Electronic Payment Company (15) for payment for services rendered by the system.

For example, Options (50) and (51) allow the user to include information about inoculations and deworming, surgical procedures, DNA testing, congenital defects, and death of a specific animal. The information entered may include a microchip number of the animal, the date, diagnosis, medical product used, procedure performed, and the results.

FIG. 44 is a flow diagram illustrating how a government representative may access and use predetermined, exemplary, functions in accordance with an exemplary embodiment of the present invention. More specifically, FIG. 44 is a flow chart showing Government Agency Entrance (103) that allows the user to transfer between different predetermined applications of the present invention. Option (53) allows the government representative or their assignee the ability to update government agency, government personnel, government sub-contractors or assignees, animal control centers, animal control offers, humane societies, humane offers, animal shelters, to research, update, or to edit information such as name, address, phone number, e-mail address, and other information about the users of the system. Option (54) allows the user to add new animal records to the system. Option (55) allows the user to query, update, or edit existing animal records. Option (56) allows the user to print selected records such as required government forms, medical records, transaction logs, inspection records, and other historical information maintained by the database in the system.

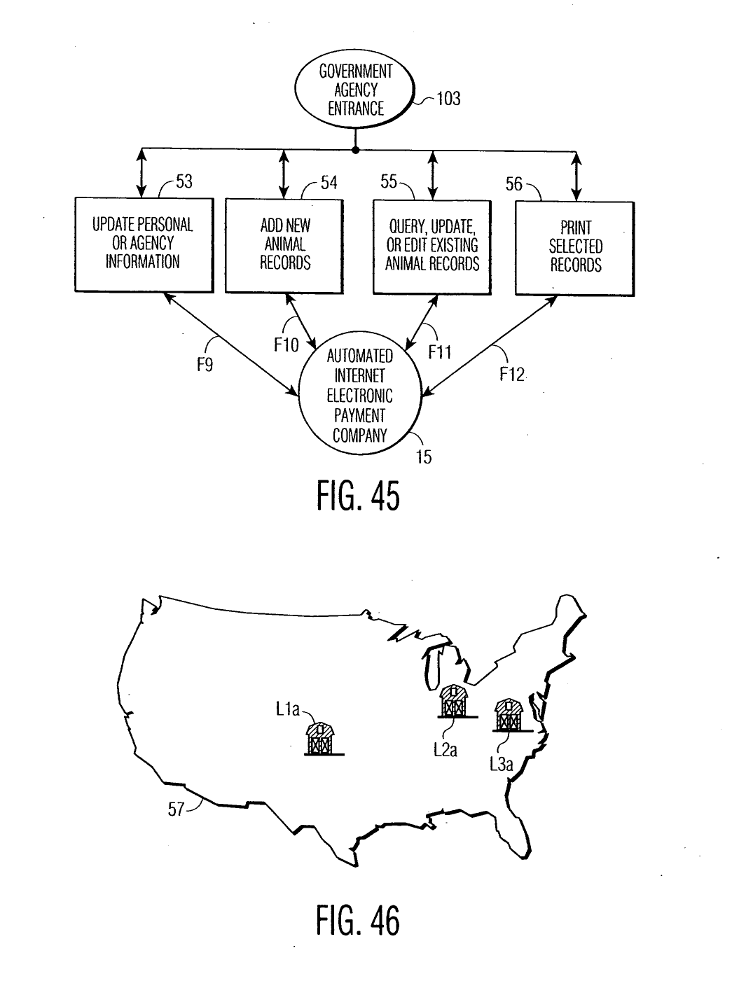

FIG. 45 is a flow diagram illustrating how a government representative may access and use predetermined, exemplary, functions in accordance with an exemplary embodiment of the present invention coupled with an automated electronic payment processing company. More specifically, FIG. 45 is an exemplary flow chart showing a Government Agency Entrance (103) that allows the user to transfer between different predetermined applications of the present invention coupled with an automated electronic payment processing company. Option (53) allows the government representative or their assignee the ability to update government agency, government personnel, government sub-contractors or assignees, animal control centers, animal control offers, humane societies, humane offers, animal shelters, to research, update, or edit information such as name, address, phone number, e-mail address, and other information about the users of the system and utilizes Transfer (F9) to transfer information to Automated Internet Electronic Payment Company (15) for payment for services rendered by the system. Option (54) allows the user to add new animal records to the system and utilizes Transfer (F10) to transfer information to Automated Internet Electronic Payment Company (15) for payment for services rendered by the system. Option (55) allows the user to query, update, or edit existing animal records and utilizes utilize Transfer (F11) to transfer information to Automated Internet Electronic Payment Company (15) for payment for services rendered by the system. Option (56) allows the user to print selected records use as required government forms, medical records, transfer logs, inspection records and other historical information maintained by the system and utilizes Transfer (F12) to transfer information to Automated Internet Electronic Payment Company (15) for payment for services rendered by the system.

The system may also allow a store to retrieve information about animals that are located in the store and are available for sale in the store, such as how long an animal has been in the store, the price paid by the store, breed, and registration number. When someone purchases an animal from a store, the store may enter information about the customer into the system such as name, address, telephone number, a description of the animal sold, including registration number, the salesperson, and method of payment, and the sale price.

FIG. 46 is a graphic overview illustrating the table in FIG. 22 in accordance with an exemplary embodiment of the present invention. More specifically, FIG. 46 shows Map (57) illustrating a geographical representation of the United States of America. Animal Location Area (L1a) is a graphic representative of Location Id Number (L1) of Table (T3) in FIG. 22. Animal Location Area (L2a) is a graphic representative of Location Id Number (L2) of Table (T3) in FIG. 22 Animal Location Area (L3a) is a graphic representative of Location Id Number (L3) of Table (T3) in FIG. 22.

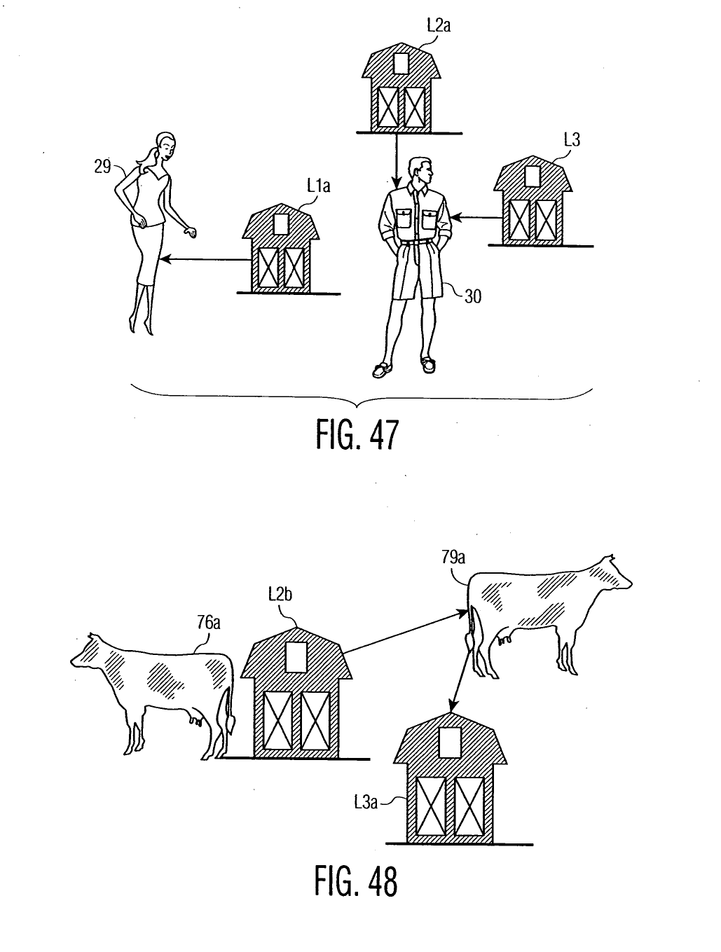

FIG. 47 is a graphic overview illustrating how an exemplary embodiment of the present invention may link multiple owners of animals to one or more physical locations. More specifically, FIG. 47 is a graphic overview illustrating Past Animal Owner (29) and her illustrative direct association with Animal Location Area (L1a). Additionally, Animal Owner (30) is shown with illustrative direct association with multiple animal locations such as illustrative Animal Location Area (L2a) and illustrative Animal Location Area (L3a).

FIG. 48 is a graphic overview illustrating the table in FIG. 22 in accordance with an exemplary embodiment of the present invention. More specifically, FIG. 48 is a graphic overview of Table (T3) in FIG. 22. Animal (76a) illustratively currently resides at illustrative Animal Location Area (L2b). Animal (79a) illustratively was transferred from illustrative Animal Location Area (L2a) to illustrative Animal Location Area (L3a).

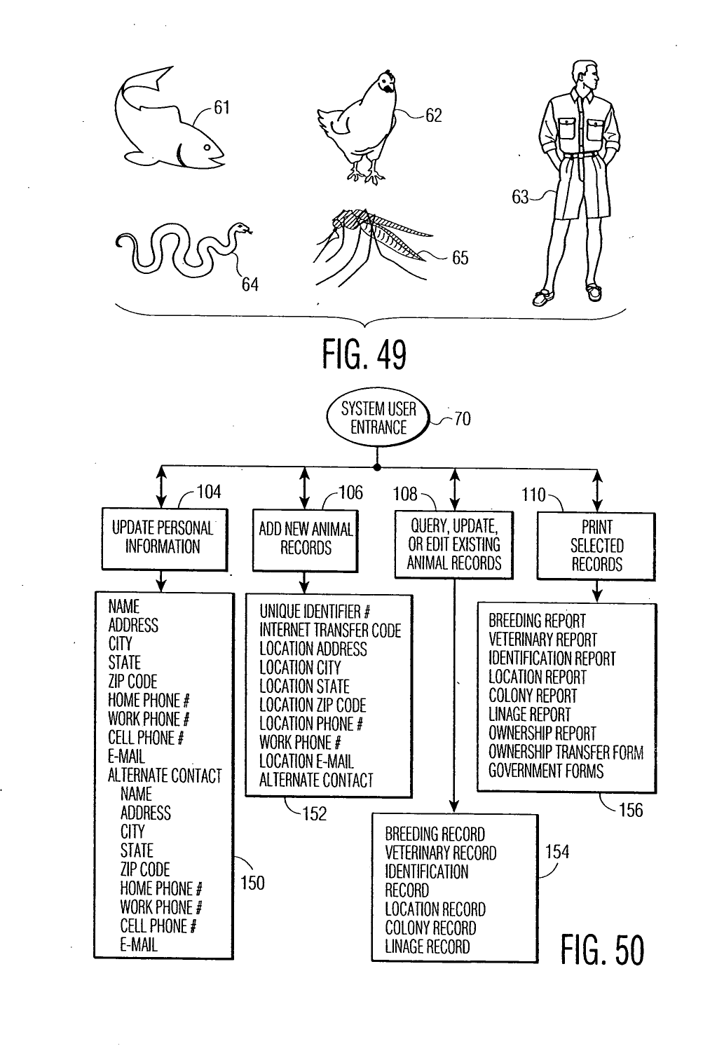

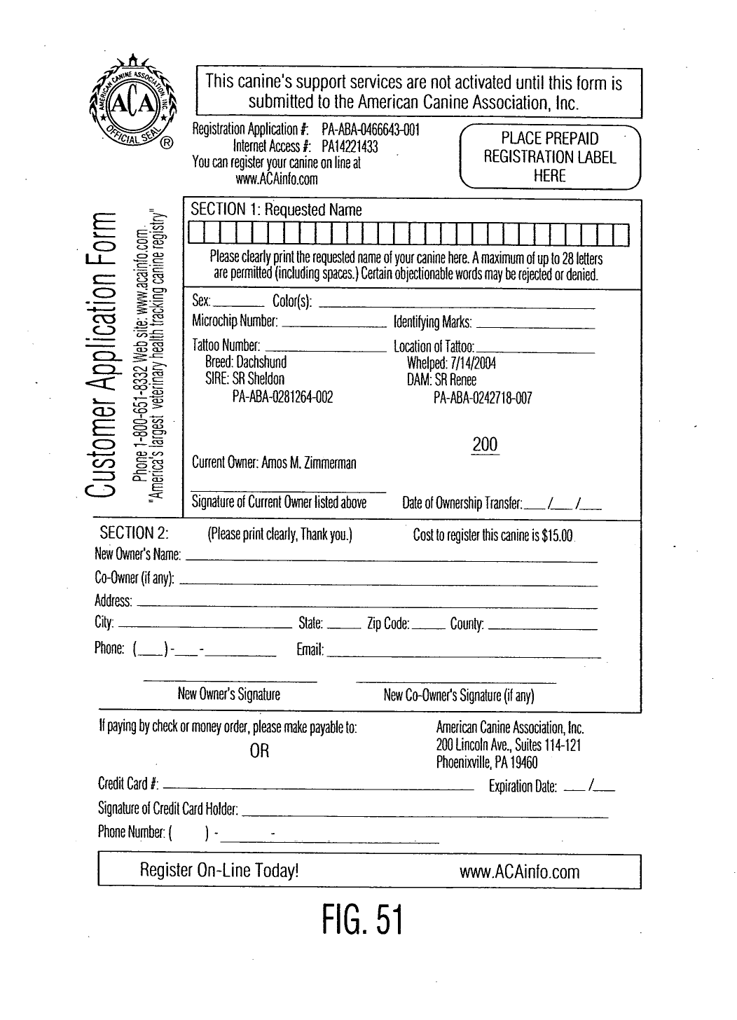

FIG. 49 is a graphic representation of other living creators that may be tracked by the present invention after having a microchip placed on or in them. More specifically, FIG. 49 is a graphic illustration of an exemplary aspect of the system that may be used to track other living creatures including, but not limited to; Aquatic Creature (61), Birds (62), Human (63), Reptile (64), Insect (65).

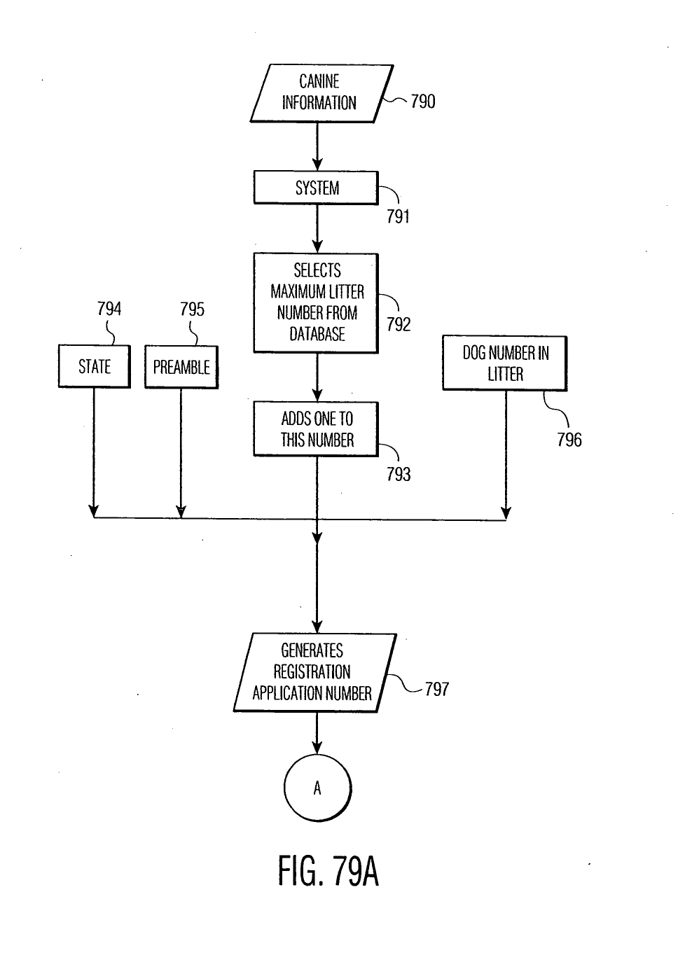

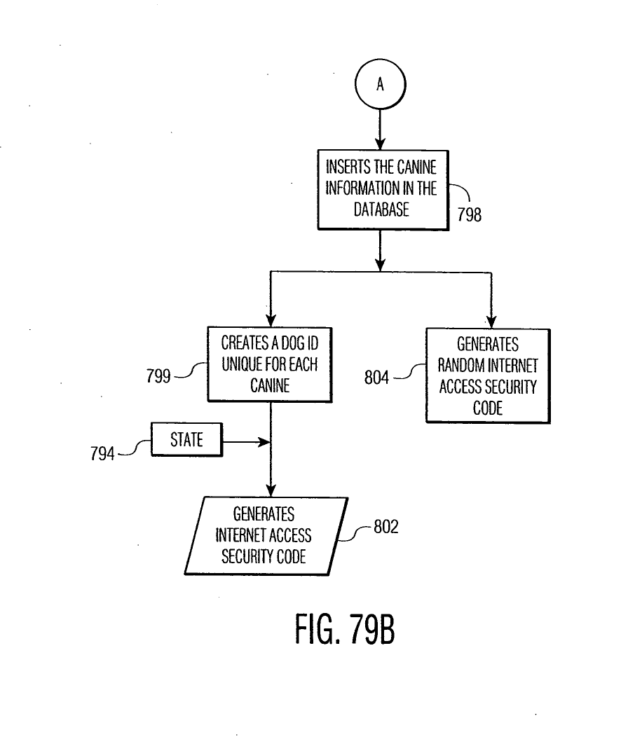

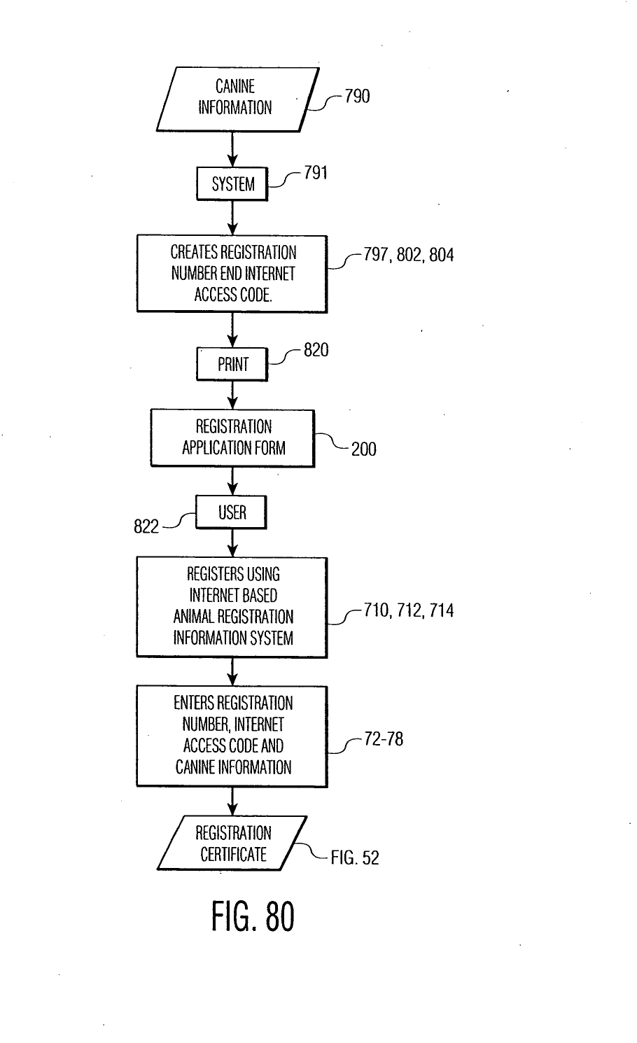

FIGS. 79A and 79B are a flow chart illustrating an exemplary method of generating a Registration Application Number and an Internet Access Security Code for an animal. Although FIGS. 79A and 79B illustrate information being entered about a canine, it will be understood that the method may be used to generate a Registration Application Number and an Internet Access Security Code for any other animal.

Referring to FIG. 79A, blocks 790 and 791 indicate that a user may enter information into a computer system about an animal. The information that is entered may include the breed of the animal, name and registration number of the sire; the name and registration number of the dam, the name of the registry, the name of the breeder, the name of the owner, whelping date, and other identifying information such as sex, color(s), identifying marks, tattoo number, and location of tattoo. In other embodiments, it will be understood that more or less information may be entered.

After the information is entered into the system, the system continues the process of generating a Registration Application Number. At block 792, the system determines how many animals in the selected species have been registered and stored in the system's database. Block 793 adds one number to the number identified in block 792. For purposes of illustration, the system may determine that 1000 canines have been registered and stored in the database. The system may then use the number 1001 as part of the process of generating a Registration Application Number. As shown by blocks 794, 795, and 796, additional information may be included in the generation of the Registration Application Number. Block 794 illustrates that the state of residence of the animal may be included; block 795 illustrates that the country of residence may be included; and block 796 illustrates that the animal's number in the litter may also be used. For example, if a litter included five animals, block 796 may indicate which animal in the litter is being registered. After all of the above information has been entered into the system, block 797 indicates that the system may generate a Registration Application Number.

Referring to FIG. 79B, after the system generates the Registration Application Number, block 798 retrieves the animal information entered in block 790 and creates a unique identification (ID) number for each animal. The unique ID number created in block 799 is then combined with the State identifier previously entered in block 799 to generate a unique Internet Access Security Code as indicated in block 802. In an alternative embodiment, after block 798 retrieves the animal information entered in block 790, step 804 indicates that the system may generate a Random Internet Access Security Code that is independent of the unique animal ID that may be created in step 799. The Random Internet Access Security Code that may be created in step 804 may use the State information entered in step 799. Alternatively, the Random Internet Access Security Code may be created without using the State information.

FIG. 80 is a flow chart illustrating an exemplary embodiment for generating a Registration Certificate for an animal. Although FIG. 80 refers to information regarding a canine, it will be understood that the method disclosed therein may be used for any animal. Referring to FIG. 80 blocks 790 and 791 illustrate the same steps that have been described in connection with FIGS. 79A and 79B. In FIG. 80, the block identified as 797, 802, 804 illustrates the same steps described in FIGS. 79A and 79B. After the system creates the Registration Application Number in block 797, the unique ID in block 799, and the Internet Access Code either in block 802 or block 804, the system may be used to print a Registration Application Form 200 as indicated by block 820.

FIG. 51 is an illustration of a Registration Application Form in accordance with an exemplary embodiment of the invention. More specifically, FIG. 51 is an illustration of an animal's Registration Application form 200 with illustrative information entered onto the form. In an exemplary embodiment of the invention, the Registration Application form may be printed by a pet store, a registry such as the American Canine Association, or a breeder, depending upon who enters the information into the system. After the Registration Application form is printed, it may be sent to an appropriate user such as an owner, pet store, customer, breeder, or other authorized user. FIG. 51 shows illustrative information that may be included on the form such as a unique animal identification number, illustrative Internet access security code, breed, name and identification number of the sire, name and identification number of the dam, whelped date, and the name of a current owner. It will be understood that Registration Application form 200 may include more or less information than is illustrated in FIG. 51.

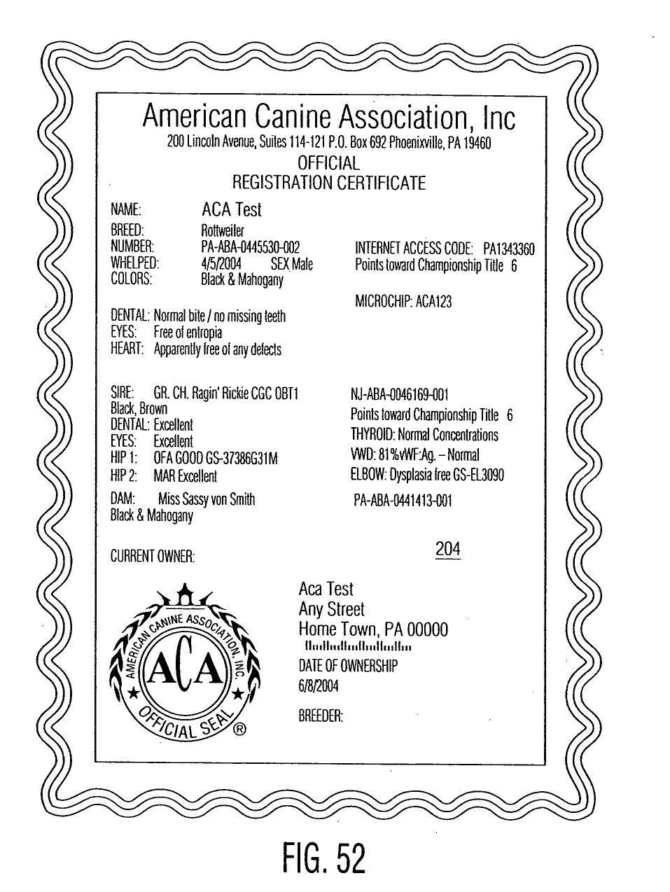

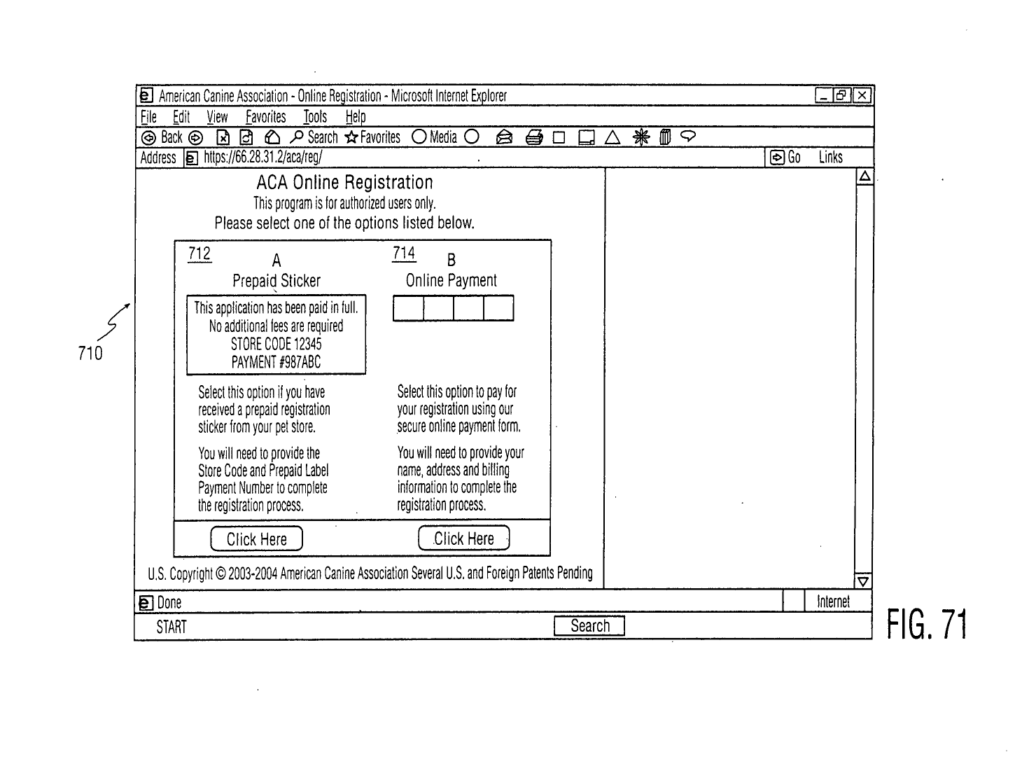

Returning to FIG. 80, after a user receives Registration Application form 200, the user may initiate registering the animal using an Internet based Animal Registration Information System as indicated in block 822. Registration will be described in connection with FIGS. 71-78 and 52. More specifically, the block identified as 710, 712, 714 is illustrated in FIG. 71.

FIG. 71 is an illustration of a screen 710 that a user such as an owner, a seller, a pet store or a breeder may use to begin a process of registering an animal online; that is, the process of registering an animal using a system and method illustrated in FIG. 56. As illustrated in screen 710, a user may be required to make a payment as a first step in the registration process. In an exemplary embodiment, Screen 710 illustrates two different ways in which a user may pay to begin a registration process. The first illustrative method is indicated by box 712. The second illustrative method is indicated by box 714.

Referring to illustrative box 712, a user may make an online payment using a Prepaid Sticker that the user may have previously purchased. The Prepaid Sticker may have been purchased from a pet store or from another source. As indicated in box 712, the user may be required to provide a store code and a prepaid sticker payment number in order to complete the registration process.

Referring to illustrative box 714, a user may make an online payment using a credit card. As indicated in illustrative box 714, the user may be required to provide his or her name, address, and billing information in order to complete the registration process. Although certain credit cards are illustrated in box 714, it will be understood that other credit cards may be used. In an alternative embodiment, other methods of payment may also be used such as a debit card or any other method that will provide a payment from the user to the entity providing the registration service.

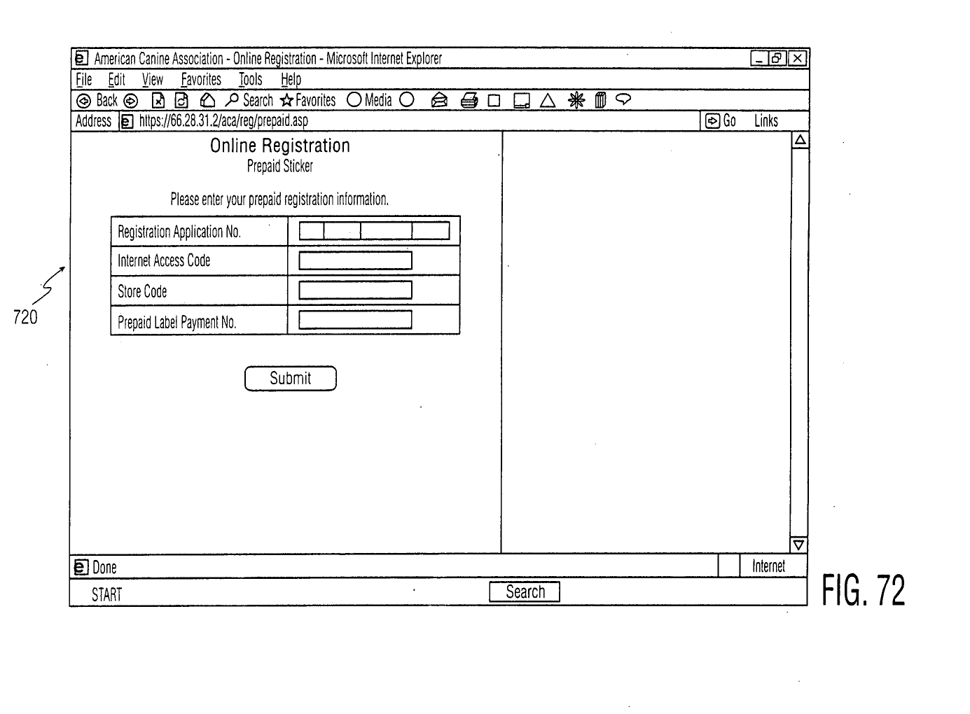

Referring back to FIG. 80, the steps represented by the block identified as 72-78 will be described in more detail with reference to FIGS. 72-78. FIG. 72 is an illustration of a screen 720 that a user may see after the user has selected Prepaid Sticker illustrated in box 712 as a mode of payment. Illustrative screen 720 may require the user to enter certain information about the transaction such as a Registration Application Number for the animal, an Internet Access Code, a code identifying the Store where the animal is being purchased, and the Prepaid Label Number of the Prepaid Sticker. It will be understood that illustrative screen 720 may ask the user to supply less, additional, or different information than is illustrated in FIG. 72.

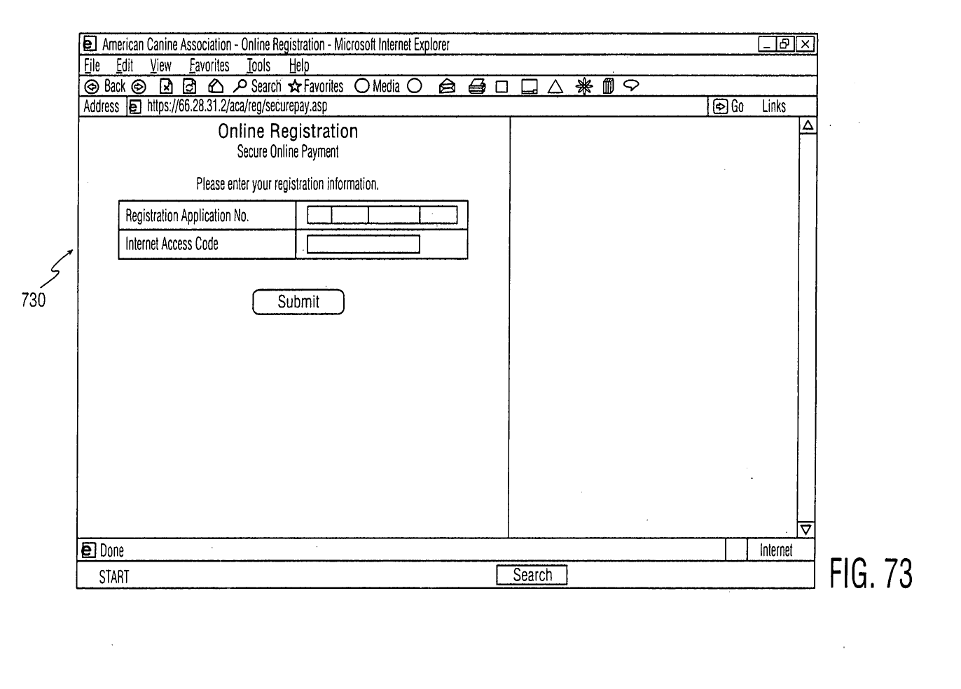

FIG. 73 is an illustration of a screen 730 that a user may see after the user has selected an online payment method illustrated in box 714 in FIG. 71 as a mode of payment. Illustrative screen 730 may require the user to enter certain information about the transaction such as Registration Application Number for the animal and an Internet Access Code. It will be understood that illustrative screen 730 may ask the user to supply less, additional, or different information than is illustrated in FIG. 73.

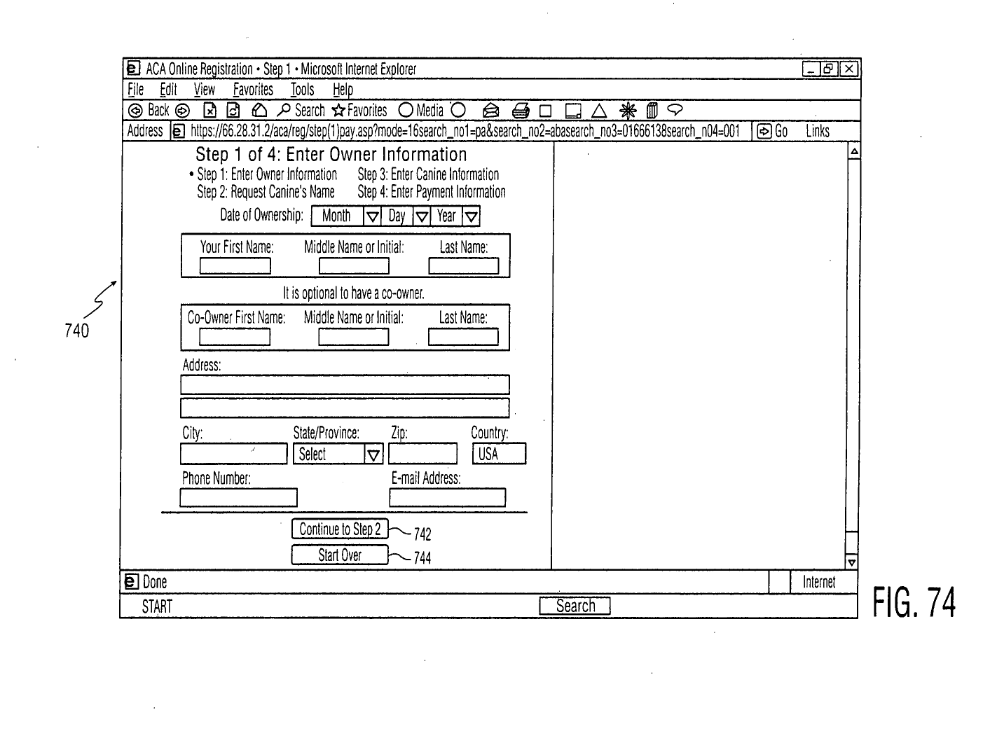

After the user selects a mode of payment, the system may direct the user to a number of follow-up screens to complete the transaction. Illustrative screens are shown in FIGS. 74 to 78, although more screens or fewer screens may be used. Furthermore, although FIGS. 74-78 illustrate a transaction involving a canine, it will be understood that the system and method illustrated in those figures may be used to register an animal of any species. In addition, even though these figures illustrate that an owner is the user who is entering the information, it will be understood that any authorized user including a breeder, pet store, or distributor may enter the information. It will also be understood that the screens in these figures may require less, additional, or different information than is illustrated in them.

FIG. 74 is an illustration of a screen 740 that may be Step 1 of an exemplary registration process. FIG. 74 illustrates that an owner may be required to enter a Date of Ownership, the owner's name and address, telephone number, and e-mail address. It will be understood that illustrative screen 740 may ask the owner to supply less, additional, or different information than is illustrated in FIG. 74. If Step 1, and the subsequent steps discussed below, are used to register an animal other than a canine, screen 740, and subsequent screens, will state the species of animal being registered. Screen 74 may give the user the option of continuing to Step 2 by selecting box 742 or starting the registration process from the beginning by selecting box 744.

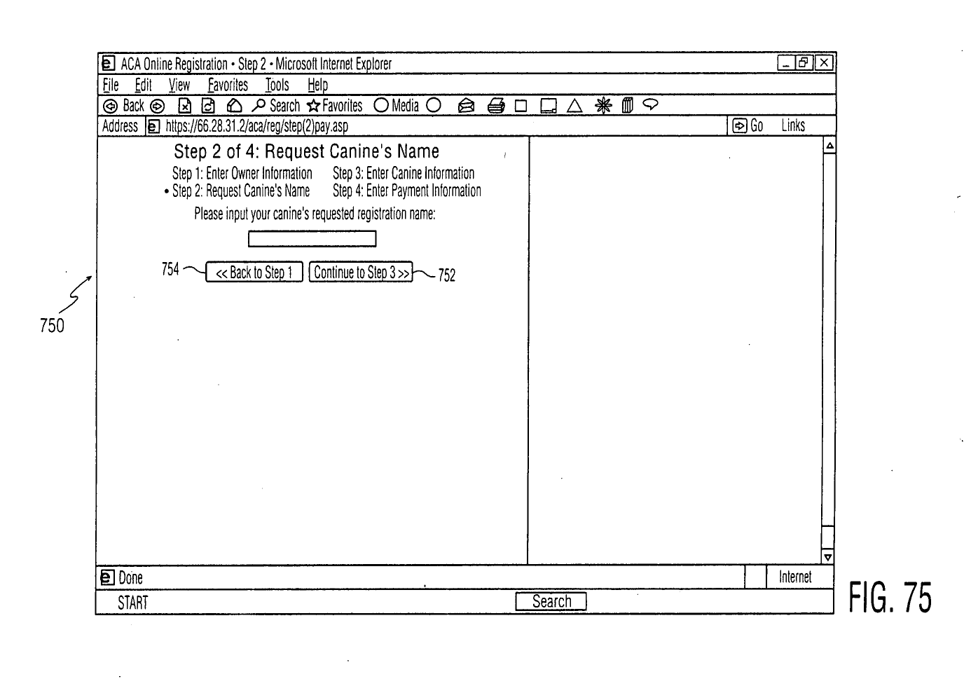

FIG. 75 is an illustration of a screen 750 that may be Step 2 of an exemplary registration process. FIG. 75 illustrates that the user may be required to enter an animal's registration name. Screen 750 may give the user the option of continuing to Step 3 by selecting box 752 or returning to Step 1 by selecting box 754.

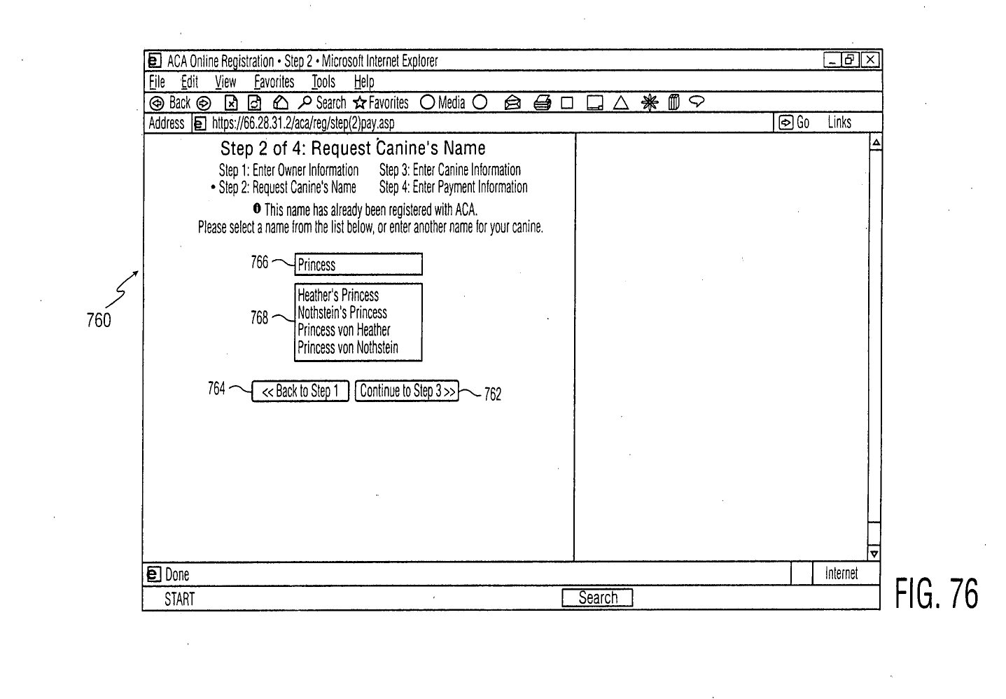

FIG. 76 is an illustration of a screen 760 that may appear as part of Step 2 of an exemplary registration process. Screen 760 may appear if the animal registration name selected in screen 750 is a name that has previously been registered by another user for the species of animal currently being registered. As shown in box 766 of illustrative screen 760, the illustrative user selected the illustrative name Princess in screen 750. Illustrative screen 760 states that the name Princess has already been registered with the illustrative ACA registration service; that is, with the American Canine Association, Inc. The system and method may provide alternative suggested names as illustrated in box 768. If a user does not select any of the alternative suggested names, the owner can select box 764 to return to Step 1. If a user does select one of the alternative names, the user may select box 762 in order to proceed to Step 3.

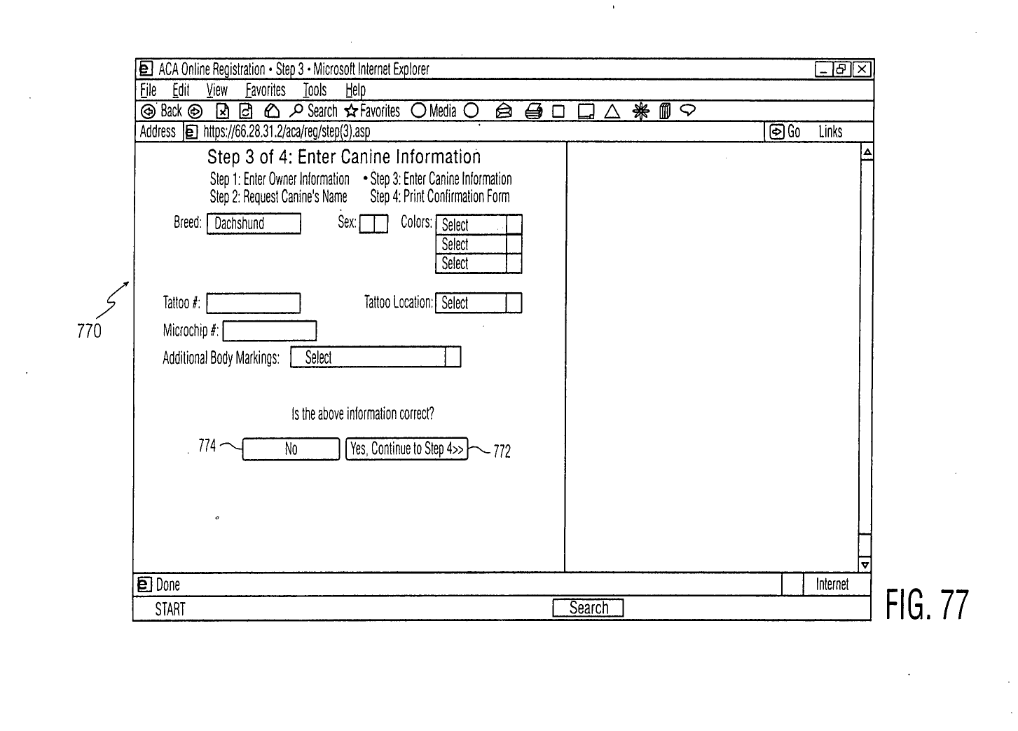

FIG. 77 is an illustration of a screen 770 that may be Step 3 of an exemplary registration process. In screen 770, a user may enter information about the animal such as the breed, sex, colors, microchip number, tattoo number, tattoo location, and body markings. It will be understood that illustrative screen 770 may ask the user to supply less, additional, or different information than is illustrated in FIG. 77. If the user is satisfied that correct information has been entered into illustrative screen 770, the user may proceed to Step 4 by selecting box 772. If the user concludes that screen 770 contains incorrect information, the user may select box 774 and then make corrections to screen 770.

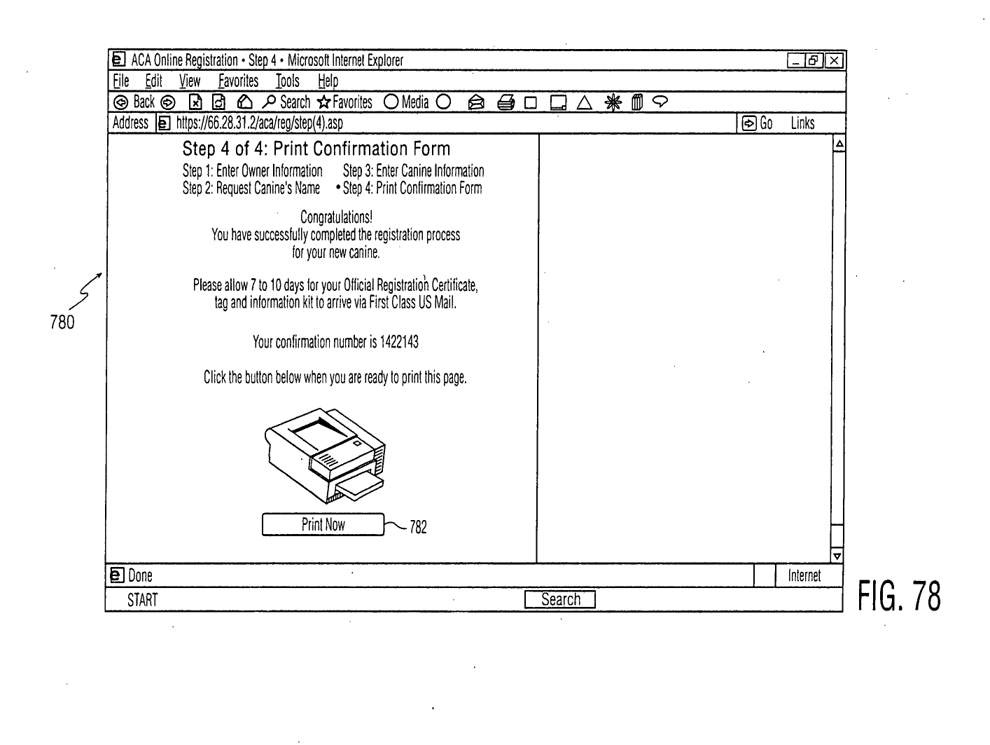

FIG. 78 is an illustration of a screen 780 that may be Step 4 of an exemplary registration process. In screen 780, a user may be informed by the system and method that registration has been successfully completed. Illustrative screen 780 shows that an illustrative confirmation number has been provided. After screen 780 appears, the user may select box 782 to print the confirmation form.

Subsequently, the user may receive an Official Registration Certificate, an exemplary embodiment of which is illustrated in FIG. 52. FIG. 52 is an illustration of an Official Registration Certificate 204 in accordance with an exemplary embodiment of the invention. More specifically, FIG. 52 is an illustration of an animal's official registration certificate 204 with an illustrative animal unique identification number and illustrative Internet access security code entered on the form, in accordance with an exemplary embodiment of the invention. Both the identification number and the security code may be randomly generated. The Registration Application No may become the Official Registration Number; but the Internet Access Security Code that may be issued in connection with Registration Application Form 200 may be deleted to prevent reuse once the Official Registration Form is issued. As a result, a new randomly generated Internet Access Security Code may be issued for the Official Registration Certificate 204. As illustrated in FIG. 52, the Official Registration Certificate may include the breed of the animal, the whelped date, the color(s) of the animal, the animal's microchip number, the name of the sire and other information about the sire, the name of the dam and other information about the dam, the name of the current owner, and date ownership began, and the name of the breeder. As illustrated in FIG. 52, the Official Registration Certificate may contain additional information about animal, its sire and its dam. It will be understood that the Official Registration Certificate may contain less information and may contain information other than the information illustrated in FIG. 52.

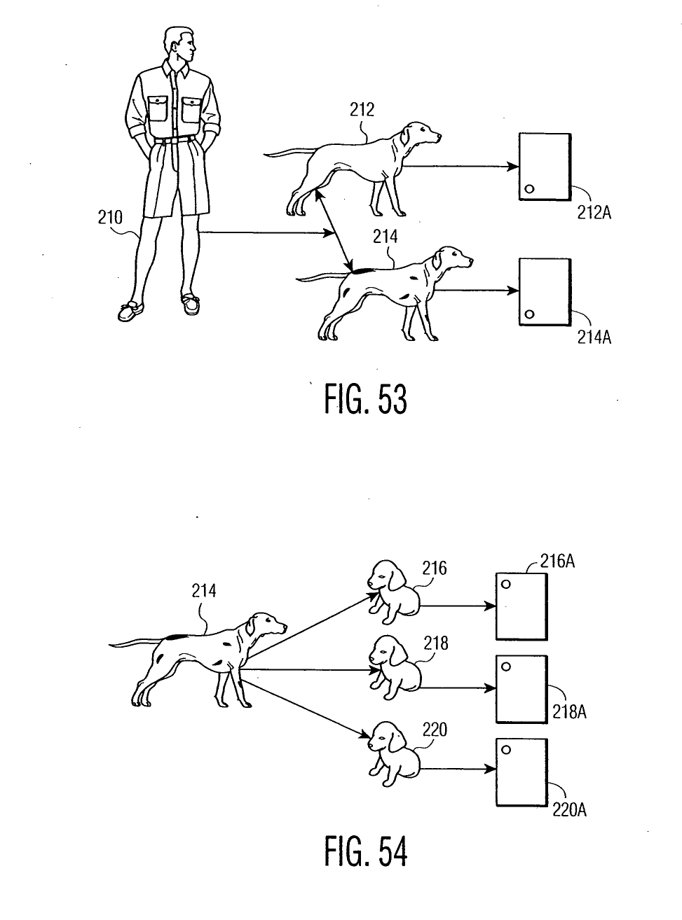

FIG. 53 is a graphic representation of an owner of an animal initiating the breeding of a male animal and a female animal to produce offspring. More specifically, FIG. 53 is a graphic representation of an Animal Owner 210 of a male animal 212 initiating the breeding of the male animal 212 and a female animal 214 to produce offspring. Even more specifically, FIG. 53 is a graphic representation of an Animal Owner 210 initiating the breeding of male Animal 212 to female Animal 214 for purposes of procreation.

In FIG. 53, male animal 212 is shown as a male canine and female animal 214 is shown as a female canine. It will be understood that the exemplary embodiment of the invention may be used with a male animal and a female animal of any species. Accordingly, it will be understood that even though many of the figures in this disclosure depict canines, the aspects of the invention shown in each of the figures may be used in connection with other species of animals.

A Registration Certificate 212A may have previously been issued for male animal 212 and a Registration Certificate 214A may have previously been issued for female animal 214. Registration Certificates 212A and 214A may contain unique identification information and numbers that are specific to the respective male animal 212 and female animal 214. Registration Certificates 212A and 214A may contain information in the format illustrated in FIG. 52.

FIG. 54 is a graphic representation of a female animal producing offspring after being bred. More specifically, FIG. 54 is a graphic representation of female Animal 214 giving birth to Offspring 216, Offspring 218, and Offspring 220 after being bred. Even though FIG. 54 illustrates three offspring, the number of offspring many range from one to the maximum number any one female species of animal may produce.

After offspring 216, 218, 220 are produced, Registration Applications may be submitted in order to register one or more of the offspring. Accordingly, Registration Application 216a may be submitted to register Offspring 216, Registration Application 218a may be submitted to register Offspring 218, and Registration Application 220a may be submitted to register Offspring 220. Information for each of the Registration Applications may be submitted by the Owner 210 if the Owner 210 breeds the two animals. Alternatively, Registration Applications may be submitted by a breeder or by a pet shop owner. When information about each Offspring is entered into the database of an exemplary embodiment of the invention, the system and method of the exemplary embodiment may automatically generate the Registration Application. Registration Applications 216A, 218A, and 220A may contain information in the format illustrated in FIG. 51.

Referring back to FIG. 51 and FIG. 52, when a Registration Application is submitted, a random application number and a random Internet Access Security Code may be provided to the person who submitted the application. If the person who submitted the application retains ownership of the animal for at least a predetermined period of time, that person will be the person who receives the Official Registration Certificate 204 shown in FIG. 52. The generation of the Registration Certificate may be performed either by the provider of the registration system or by the owner of the animal. If the owner generates the Registration Certificate, the owner does not have to wait for the provider of the registration service to print and mail the certificate to the owner. The exemplary embodiment of the system may also allow the owner of the animal to print additional copies of the Registration Certificate as needed. Additionally, the exemplary system may optionally allow the owner to print breeding records and/or any required government forms, such as Federal and State Department of Agriculture forms for example. In one exemplary embodiment of the present invention, government forms may be at least partially filled out by the system and method using information in data fields stored in a database.

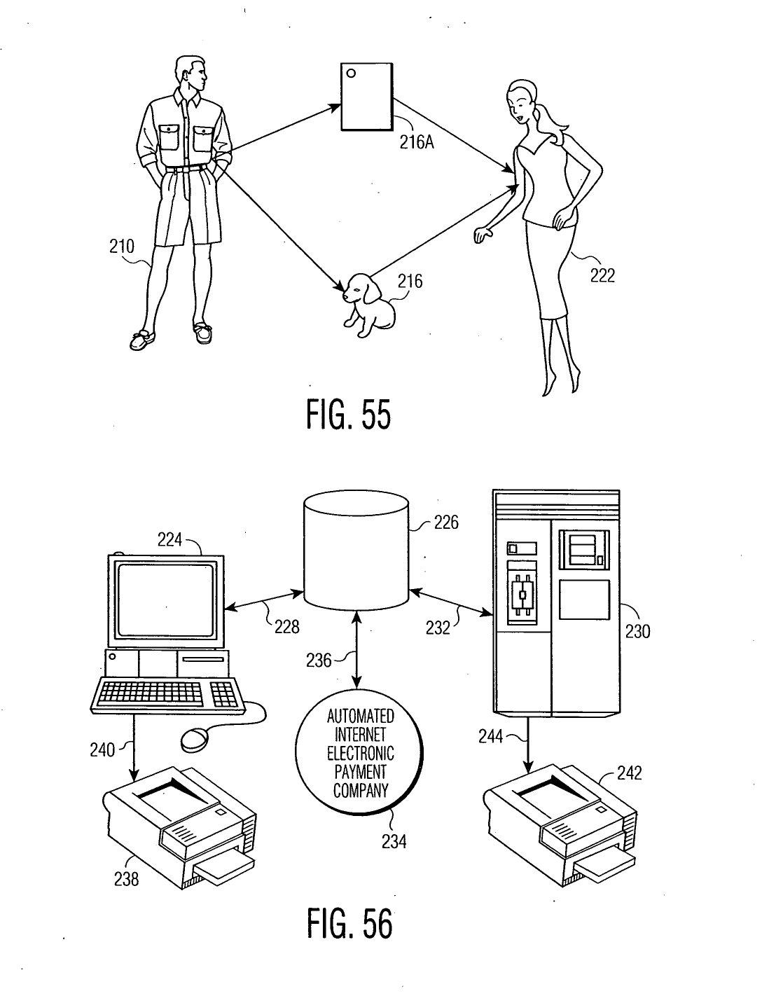

FIG. 55 is a graphic representation of the transfer of ownership of an animal's offspring to a new owner. More specifically, FIG. 55 is a graphic representation of the transfer of ownership of offspring 216 of animal 214 to a new owner 222. Even more specifically, FIG. 55 is a graphic representation of Animal Owner 210 transferring ownership of Offspring 216 to new owner 222 who is now an Offspring Owner. If Owner 210 transfers ownership of Offspring 216 before Registration Application 216A has been processed, Owner 210 may transfer printed Registration Application 216A to New Owner 222 along with Offspring 216. Alternatively, if Owner 210 already possesses an Official Registration Certificate with the illustrative information contained in a Certificate such as illustrative Certificate 204 shown in FIG. 52 for Offspring 216, Owner 210 may transfer the Official Registration Certificate to New Owner 222 along with the sale of Offspring 216.

FIG. 56 is an overview illustrating a manner in which a user may access an exemplary embodiment of the present invention when it is coupled to an automated electronic payment processing company, entity, or system in accordance with an exemplary embodiment of the invention. FIG. 56 is also an overview illustrating a manner in which a user may access information stored by the present invention when the invention is coupled to an automated electronic payment processing system or entity in accordance with an exemplary embodiment of the invention. In an alternative embodiment, the invention need not be coupled to an automated electronic payment process system or entity. More specifically, FIG. 56 is an overview illustrating a system and method by which a user may access an exemplary embodiment of the present invention when both the user and the invention are coupled to an automated electronic payment processing company, in accordance with an exemplary embodiment of the invention. Even more particularly, FIG. 56 is a graphic overview illustration depicting an exemplary system and method by which a user may access the present invention via an illustrative Internet Access Device 224. In an exemplary embodiment, illustrative Internet Access Device 224 may be any one of many known Internet access devices such as Microsoft Corporation's MSN TV receiver, model number RM2100, manufactured by RCA, or Hitachi SH-G1000 Pocket PC Phone Edition 2002 from Sprint PCS, PDA (personal digital assistant), or other hand held device or other personal computer along with Internet connection access devices. Illustrative Internet Access Device 224 may be connected to the World Wide Web 226, or other information network, via a Connection 228 that may be any one of many known forms such as a telephone hardwired modem, a cable TV, DSL, T1, T2, T3, wireless modem, satellite, or other device that may be used to connect the invention to the Internet or to another information network.

The invention's illustrative Server 230 may be connected to the World Wide Web 226 or other information network via Connection 232. Connection 232 may be any one of many forms such as a telephone hardwired modem, a cable TV, DSL, T1, T2, T3, wireless modem, satellite, or other device that may be used to connect the invention to the Internet or to another information network. An exemplary embodiment of the invention may also use an Automated Internet Electronic Payment Company 234, which may allow for paperless, electronic, and unmanned payment for services to the company that hosts the illustrative Internet Server 230. Automated Internet Electronic Payment Company 234 may utilize an Internet Connection 236 which may be any one of many forms of access to the Internet or other information network such as a telephone hardwired modem, cable TV, DSL, T1, T2, T3, wireless modem, satellite, or other device that may be used to connect the invention to the Internet or to another information network. Internet Connection 236 may connect the Automated Electronic Payment Company 234 to the Access Device 224 and to the Server 230.

The user may also use one or more optional printing capabilities. An exemplary embodiment of the user's optional printing capabilities is also illustrated in FIG. 56, where illustrative Access Device 224 is shown as being connected to illustrative Printer 238 via a Printer Connection 240. Printer Connection 240 may be comprised of any one of many forms of printer connections such as a parallel port cable, a serial cable, a fire-wire cable, a LAN CAT-5 cable, a wireless broadband router signal, or other printer connection. Similarly, the company hosting the illustrative Server 230 may also have optional printing capabilities as illustrated in FIG. 56. As shown in FIG. 56, illustrative Server 230 may be connected to an illustrative Printer 242 via a Printer Connection 244. Printer Connection 244 may be comprised of any one of many forms of printer connections such as a parallel port cable, a serial cable, a fire-wire cable, a LAN CAT-5 cable, a wireless broadband router signal, or other equivalent printer connection.

Referring to FIG. 56, an owner of animals may enter information about an animal using illustrative Access Device 224. The information entered by the owner may be transmitted to illustrative Server 230 via the World Wide Web or other information network and connections 228 and 232. After the owner enters the information, the owner may print the information on illustrative Printer 238. Similarly, a new owner, a breeder, or a pet store may enter information into the system's database via illustrative Access Device 224 and may print the entered information on illustrative Printer 238. In an exemplary embodiment, illustrative Server 230 may be a remote server that is owned and/or controlled by a national database management computer server. In an alternative embodiment, illustrative Server 230 may be a local server that is owned by a user or by an owner or by a new owner. When illustrative Server 230 is a local server, it may be integrated with the computer of the user, owner, or new owner.

An owner, a new owner, a breeder, or a pet store may pay for the opportunity of using a database stored on illustrative Server 230 by paying through automated internet electronic payment company 234. Payment may be made for each individual transaction as information is entered for each animal and each offspring. Alternatively, a seller of animals such as, for example, a pet store or a breeder of animals may purchase one or more coupons in anticipation of future sales and further breedings. The purchase may be accomplished through the automated internet electronic payment company 234 over the World Wide Web or other information network and connection 236. After the seller or breeder purchases the coupons, the seller or breeder may print the coupons on illustrative Printer 238. Each prepaid coupon may have a unique number which may be assigned to the seller, breeder, or pet store. This number may identify the seller, breeder, or pet store that engages in a particular transaction. Each coupon may also have a randomized Internet security access number.

When the seller, breeder, or pet store first acquires an animal or offspring, the seller, breeder, or pet store may enter information into the system about the animal or offspring. When the seller, breeder, or pet store sells an animal or offspring to a new owner, the seller, breeder, or pet store may provide a preprinted coupon to the new owner along with a printed Registration Application such as illustrative Form 200 or an issued Official Registration Certificate such as illustrative Certificate 204. The new owner may then enter his or her information about the purchased animal, including the numbers on the coupon. Since the numbers on the coupon may be unique to the seller, breeder or pet store and may be unique to the animal being transferred, the system may be able to trace location information and other information about an animal from a seller, breeder, or pet store to a new owner. Once the new owner enters his or her information into the system along with the coupon number, the system for security purposes may delete the randomized Internet security access number that had been assigned to the prepaid coupon to prevent reuse. The randomized Internet security access number may no longer be needed because the new owner may be assigned a new randomized Internet security access number.

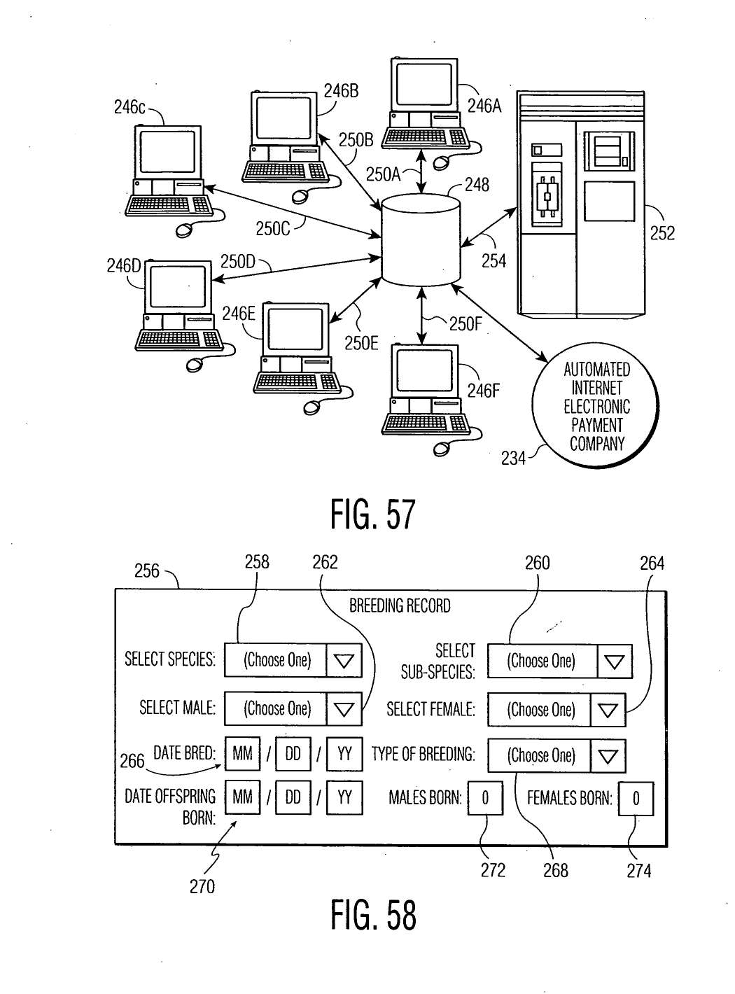

FIG. 57 is an overview illustrating a manner in which multiple users may access an exemplary embodiment of the present invention when it is coupled to an automated electronic payment processing company in accordance with an exemplary embodiment of the invention. FIG. 57 is an overview illustrating a manner in which multiple users may enter information or may access information that has been previously stored in an exemplary embodiment of the present invention when it is coupled to an automated electronic payment processing company, entity, or system 234 in accordance with an exemplary embodiment of the invention. In an alternative embodiment, the invention need not be coupled to an automated electronic payment processing company. More specifically, FIG. 57 is a graphic overview illustrating a system and method by which multiple users may access an exemplary embodiment of the present invention. Even more specifically, FIG. 57 is an overview illustrating an exemplary embodiment of a system and method by which multiple access devices may simultaneously access an exemplary embodiment of the present invention. For example, illustrative Access Device 246A may access World Wide Web 248 or other information network via Connection 250A; illustrative Access Device 246B may access World Wide Web 248 or other information network via Connection 250B; illustrative Access Device 246C may access World Wide Web 248 or other information network via Connection 250C; illustrative Access Device 246D may access World Wide Web 248 or other information network via Internet Connection 250d. Similarly, illustrative Access Devices 246E and 246F may access World Wide Web 248 or other information network via Connections 250E and 250F, respectively. World Wide Web 248 or other information network may connect illustrative Server 252 via Connection 254 and Connections 250A to 250F to some or all of the illustrative Access Devices 246A to 246F. It will be understood that the invention may comprise a fewer number or a greater number of Access Devices and connections than are shown in FIG. 57. Some or all Access Devices may register animals in accordance with the system and method described in FIGS. 71 to 78.

One or more authorized users may enter breeding information into the system about one or more animals. As illustrated in FIG. 57, one or more users may enter breeding information simultaneously. FIG. 58 is an illustration of a Breeding Record Screen 256 in accordance with an exemplary embodiment of the invention. More specifically, FIG. 58 is an illustration of a Breeding Record Screen before information is entered by a user. Even more specifically, Breeding Record Screen 256 may include a Select Species field 258, a Select Sub-Species field 260, a Select Male name field 262, a Select Female name field 264, a Date Bred field 266, a Type of Breeding field 268, a Date Offspring Born field 270, a Number of Males Born field 272, and a Number of Females Born field 274.

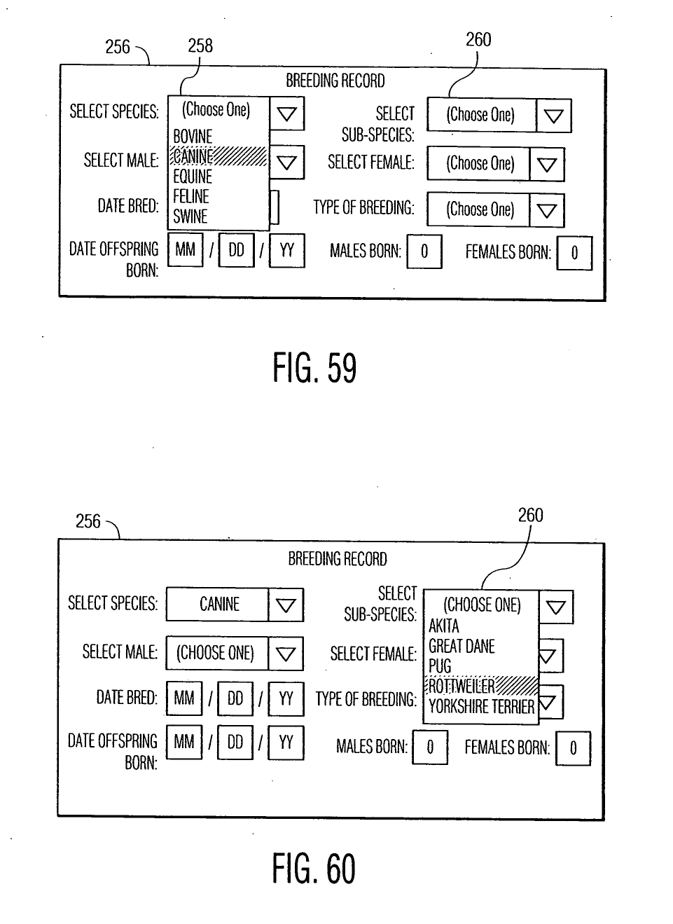

FIG. 59 is an illustration of a Select Species field 258 on a Breeding Record Screen 256 that may be accessed by a user in accordance with an exemplary embodiment of the invention. More specifically, FIG. 59 illustrates an exemplary embodiment of a drop down selection screen that a user may see when viewing a Select Species field 258. The information shown in the exemplary Select Species field 258 in FIG. 59 may be unique to the user of Breeding Record 256. More specifically, in the example shown in FIG. 59, the illustrative user has previously entered information into the system identifying the type of species owned by the user. Even more specifically, the illustrative Select Species field 258 shows that the illustrative user owns or possesses animals in the bovine species, the canine species, the equine species, the feline species, and the swine species. It will be understood that other users may own or possess more species, fewer species, or different species than are illustrated in FIG. 59. An authorized user may view the information illustrated in FIG. 59 at any time, regardless of whether the user has, or is about to, mate any of his animals.

After the user illustrated in FIG. 59 breeds animals, the user may then enter information about the breeding. Using the Select Species field 258 illustrated in FIG. 59, the user may select the species of animal that the user has bred. In the exemplary embodiment shown in FIG. 59, the illustrative drop down screen allows the illustrative user to choose from a list including bovine, canine, equine, feline, and swine. In an alternative embodiment, the drop down screen may include a fewer number of species or may include other species in addition to the ones listed in FIG. 59. FIG. 59 illustrates that the illustrative user has selected Canine as the Species. In an alternative embodiment, if the user has bred an animal of a species that is not yet listed, the user may enter the name of the bred species. When the additional species name is entered, the drop down selection screen will then provide the user with that additional name when the user selects the Select Species field 258.

FIG. 60 is an illustration of a Select Sub-Species field 260 on a Breeding Record Screen that may be accessed by a user in accordance with an exemplary embodiment of the invention. The information shown in the Select Sub-Species field 260 in FIG. 60 may be unique to the illustrative user of Breeding Record 256. More specifically, in the example shown in FIG. 60, the illustrative user has previously entered information into the system identifying the type of sub-species owned by the user. Even more specifically, the illustrative Select Sub-Species field 260 shows that the illustrative user has Canines in the Akita sub-species, the Great Dane sub-species, the Pug sub-species, the Rottweiler sub-species, and the Yorkshire Terrier sub-species. It will be understood that other users may own or possess more sub-species, fewer sub-species, or different sub-species than are shown in FIG. 60. An authorized user may view the information illustrated in FIG. 60 at any time, regardless of whether the user has, or is about to, mate any of his animals.

The drop down screen 260 may allow the user to choose a sub-species. In FIG. 60, the illustrative user has selected Rottweiler as the Sub-Species of Canines that has been bred. In an alternative embodiment, if the illustrative user has bred an animal of a sub-species that is not yet listed, the user may enter the name of the bred sub-species. When the additional sub-species name is entered, the drop down selection screen may then provide the user with that additional name when the user selects the selects Sub-Species field 260.

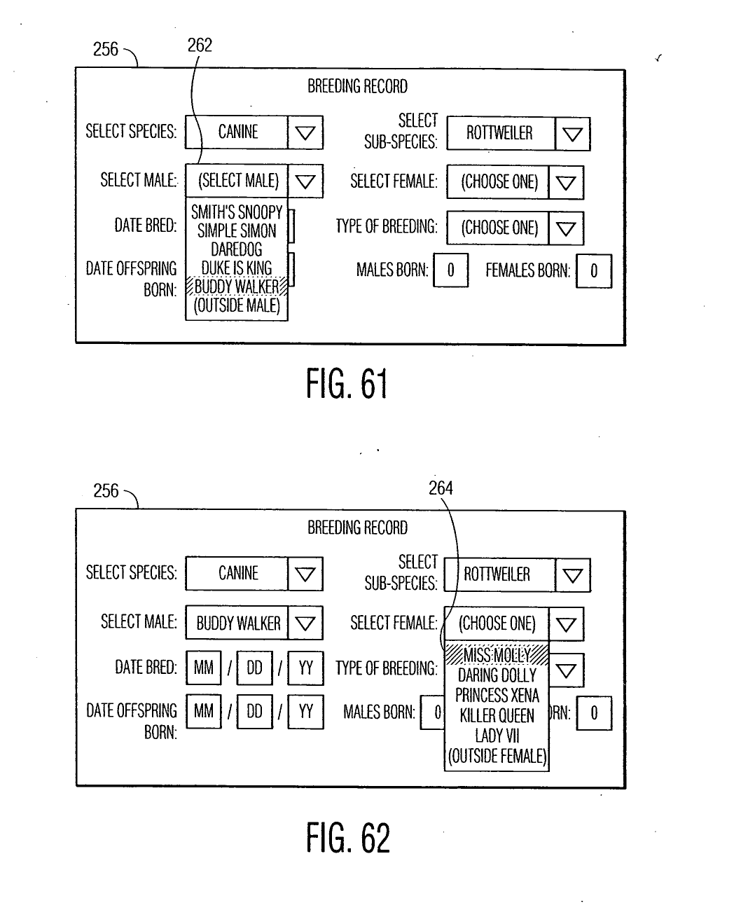

FIG. 61 is an illustration of a Select Male Name field 262 on a Breeding Record Screen that may be accessed by a user in accordance with an exemplary embodiment of the invention. In the example shown in FIG. 61, the illustrative user has previously entered information into the system identifying the names of the illustrative user's Canine Rottwilers owned or possessed by the user. Even more specifically, the illustrative Select Male field in drop down 262 shows that the exemplary user had Canine Rottweilers named Smith's Snoopy, Simple Simon, Dare Dog, Duke is King and Buddy Walker. It will be understood that other animal owners may have fewer Canine Rottweilers, more Canine Rottweilers, Canine Rottweilers with different names than are shown in FIG. 61, or no Canine Rottweilers at all. An authorized user may view the information illustrated in FIG. 61 at any time, regardless of whether the user has, or is about to, mate any of his animals.

FIG. 61 illustrates that the illustrative user has selected Buddy Walker as the Male Canine Rottweiler that has been bred. In the embodiment illustrated in FIG. 61, the illustrative user is the owner of the Canine Rottweiler named Buddy Walker. In an alternative embodiment, if the user has bred an animal having a name that is not yet listed, the user may enter the name of the bred animal. When the additional name is entered, the drop down selection screen may then provide the user with that additional name when the user selects the Select Male field 262.

FIG. 62 is an illustration of a Select Female Name field 264 on a Breeding Record Screen that may be accessed by a user in accordance with an exemplary embodiment of a drop down screen that a user may see when viewing a Select Female Name field 264 of a Breeding Record Screen 256. More specifically, FIG. 62 illustrates a drop down screen that a user may see when viewing a Select Female Name field 264 of a Breeding Record Screen 256. The illustrative drop down screen 264 may allow the illustrative user to choose from a list of names illustrative Drop down screen 264 illustrates the names Miss Molly, Daring Dolly, Princess Xena, Killer Queen, and Lady VII. In an alternative embodiment, there may be more or fewer names from which to choose. The number of names may depend upon the number of female Canine Rottweilers that are owned by the user. FIG. 62 illustrates that the illustrative user has selected Miss Molly as the Female Canine Rottweiler that has been bred with the Male Canine Rottweiler Buddy Walker.

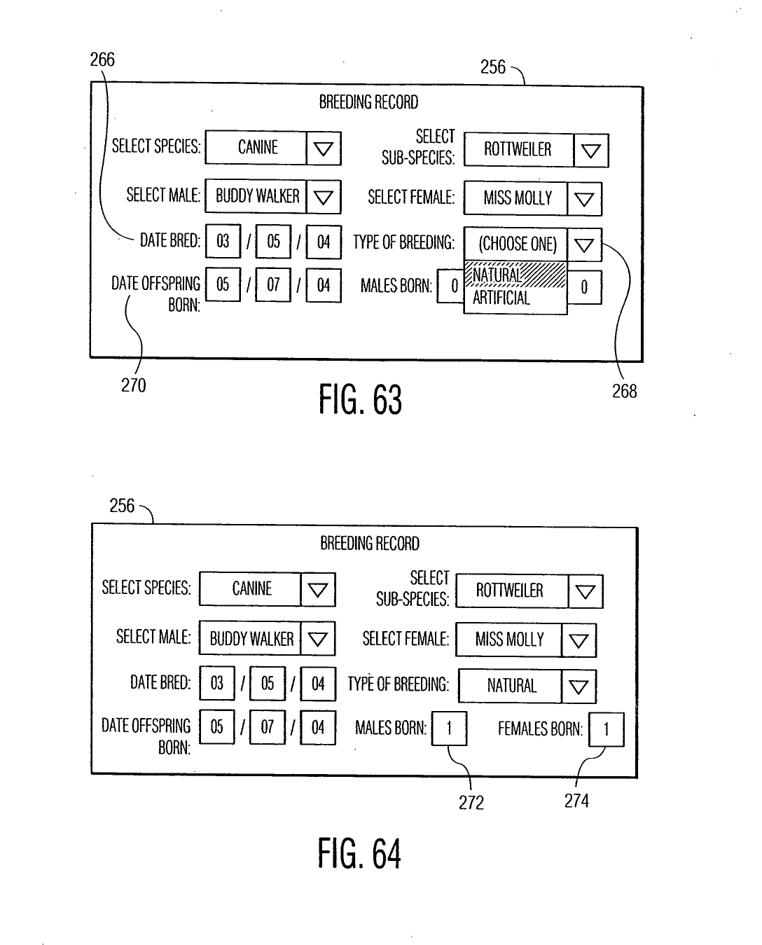

FIG. 63 is an illustration of a Breeding Record field and date input files on a Breeding Record Screen that may be accessed by a user in accordance with an exemplary embodiment of the invention. More specifically, FIG. 63 illustrates an exemplary embodiment of a drop down screen that may be accessed by a user in accordance with an exemplary embodiment of the invention. It illustrates a Type of Breeding field 268 of a Breeding Record Screen 256. It also illustrates an exemplary embodiment of a Date Bred Screen 266 and a Date Offspring Born screen 270 that a user may see when viewing Screens 266 and 270. These screens may allow the user to input the Date Bred as well as the Date Offspring Born and the Type of Breeding that was used. In the illustration shown in FIG. 63, the illustrative user has entered into the Date Bred field 266 illustrative information showing that illustrative animals were bred on Mar. 5, 2004, the Date Offspring Born showing that one or more offspring were born on May 7, 2004, and that the Type of Breeding was Natural.

FIG. 64 is an illustration of a Breeding Record Screen 256 that has been completed by an illustrative user, including an illustrative number of males and females born, that may be accessed by an authorized user in accordance with an exemplary embodiment of the invention. More specifically, FIG. 64 illustrates an exemplary embodiment of an illustrative completed Breeding Record Screen 256 where the illustrative user has entered the number of males born into the Males Born field 272 and the number of females born into the Females Born field 274 and where the entire screen has been filled out. In the illustration shown in FIG. 64, the illustrative user has entered information showing that one male Canine Rottweiler and one female Canine Rottweiler were born on May 7, 2004.

The exemplary embodiment of a breeding record, including a system and a method of creating a breeding record described in FIG. 58 through FIG. 64, may be used when a single owner owns both the male animal and the female animal. In an alternative embodiment, one owner may own the male animal and a second owner may own the female animal. In such an alternative embodiment, the information may be entered into the system either by the owner of the male animal or by the owner of the female animal.

In addition, the exemplary system and the exemplary method illustrated is shown in FIG. 58 through FIG. 64 as comprising a single screen (for example) with numerous drop down displays. In an alternative embodiment, the system and method may use a plurality of screens instead of drop down displays. Referring to FIG. 58, for example, when a user desires to enter the Select Species field 258, the user may select the down arrow for Select species field 258; but, instead of providing a drop down display as shown in FIG. 59, a new screen may appear with the names of the various males. When a name is chosen from the choice of names on the new screen, the system and method may return to the Breeding Record illustrated in FIG. 58 to enable the user to select the next entry. If, for example, the user selects the down arrow in the Select Female field 264 in FIG. 58, a new screen with the pertinent information may be provided to the user instead of the drop down display illustrated in FIG. 62. Similarly, an alternative embodiment may present a new screen with the pertinent information instead of presenting the other illustrative drop down displays.

The exemplary embodiment of the system and method illustrated in FIG. 58 to FIG. 64 illustrates a system and method for creating a breeding record when two animals of the same species are bred together and when two animals of the same species and sub-species are bred together. Although not illustrated in these figures, the system and method of the present invention may also be used to create a breeding record when two different species are bred together, when two different sub-species of the same species are bred together and when two different sub-species of two different species are bred together. For example, and not by way of limitation, a breeding record may be made showing the breeding of a Canine Pekinese with a Canine Poodle.

The following discussion refers to the owner of a female and the owner of a male. It will be understood that the discussion may also apply to a non-owner possessor of a male and to a non-owner possessor of a female. The invention may also allow the owner of a female animal to record breeding information when the female is bred with a male that is not owned by the owner of the female and is registered in the system's database. For example, it may allow the registration of information about the outside male when the owner of the female has borrowed a male animal from another source. FIG. 65 is an illustration of another Breeding Record Screen providing a system and a method to indicate use of an outside male in accordance with an exemplary embodiment of the invention. More specifically FIG. 65 illustrates a screen 276 containing a Select Male Name field 262. In an exemplary embodiment, Select Male Name field 262 may include a drop down display with a previously entered entry (Outside Male). In an alternative embodiment, the entry (Outside Male) may not have been previously entered. Instead, the system and method may allow an owner of the female to enter (Outside Male) to indicate that the female will be or was bred with an Outside Male.

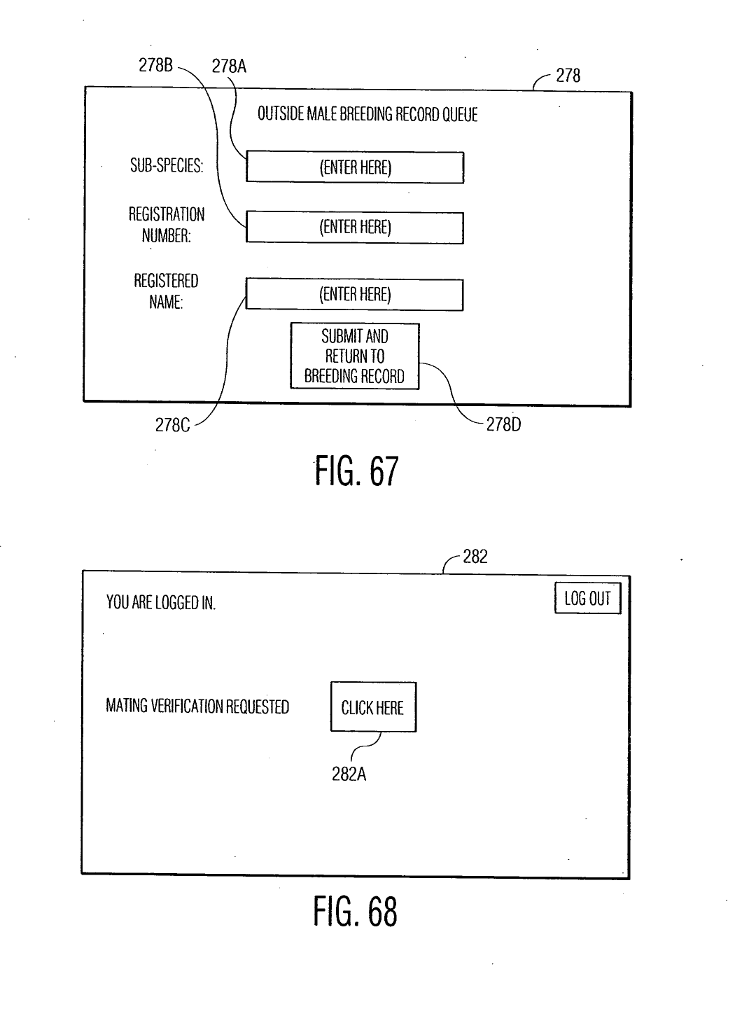

FIG. 67 is an illustration of an Outside Male Breeding Record Queue 278 in accordance with an exemplary embodiment of the invention. When “(Outside Male)” has been entered in FIG. 65, the Outside Male Breeding Record Queue 278 shown in FIG. 67 may appear on the screen. FIG. 67 may allow the owner of the female to enter information about the Outside Male which will be, or has been, bred to the female. When the Outside Male Breeding Record Queue 278 illustrated in FIG. 67 is displayed, the owner of the female animal may enter the type of sub-species of the male in Sub-Species field 278A, the registration number of the male in Registration Number field 278B, and the Registered Name of the male in the Registered Name field 278C.

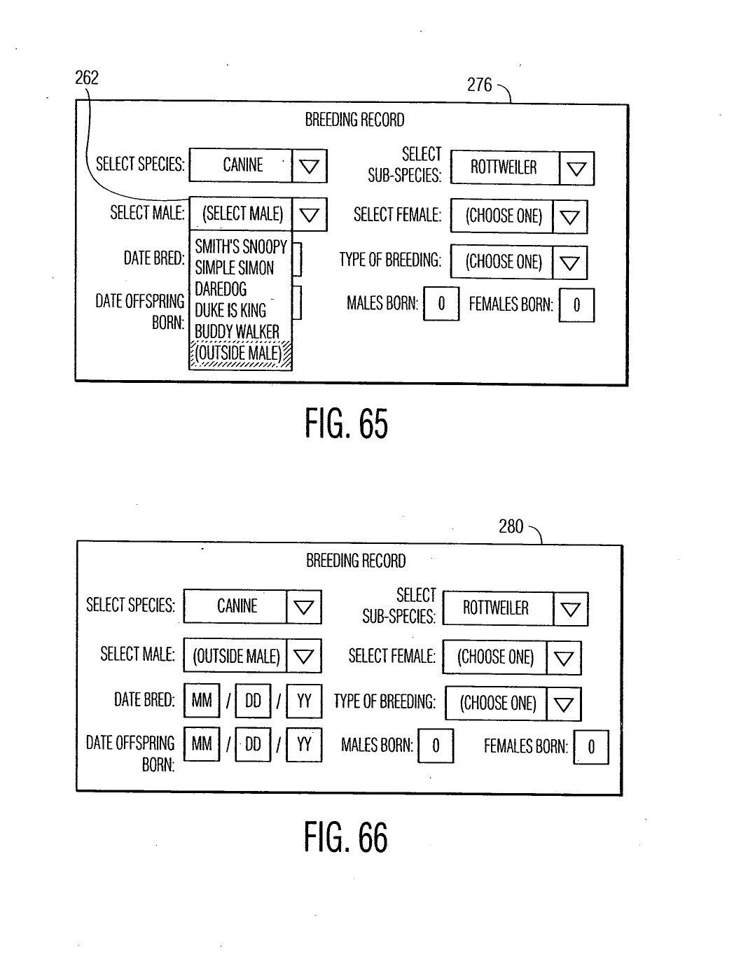

When all three fields, 278A, 278B, and 278C have been entered, the Outside Male Breeding Record Queue may display illustrative message 278D: Submit and Return to Breeding Record. At that time, the owner of the female may select illustrative message 278D. When the illustrative owner of the female selects illustrative message 278D, the two following steps may occur. First, the information may be transmitted to the owner of the Outside Male requesting the owner of the Outside Male to verify the information that has been entered about the Outside Male on screen 278 by the owner of the female. Second, an authorized user may view the Breeding Record illustrated in FIG. 66.

When the owner of the female enters the illustrative information in screen 278 and selects message 278D in FIG. 67, a message may be displayed on the screen of the owner of the Outside Male in the form illustrated by screen display 282 in FIG. 68. The illustrative message shown in FIG. 68 requests the owner of the Outside Male to verify the illustrative information that had been entered by the owner of the female in screen 278. The verification process may be performed at any time that is convenient for the owner of the Outside Male. However, the system may not allow registration of offspring from breeding the female with the Outside Male until the owner of the Outside Male verifies the information entered by the owner of the female.

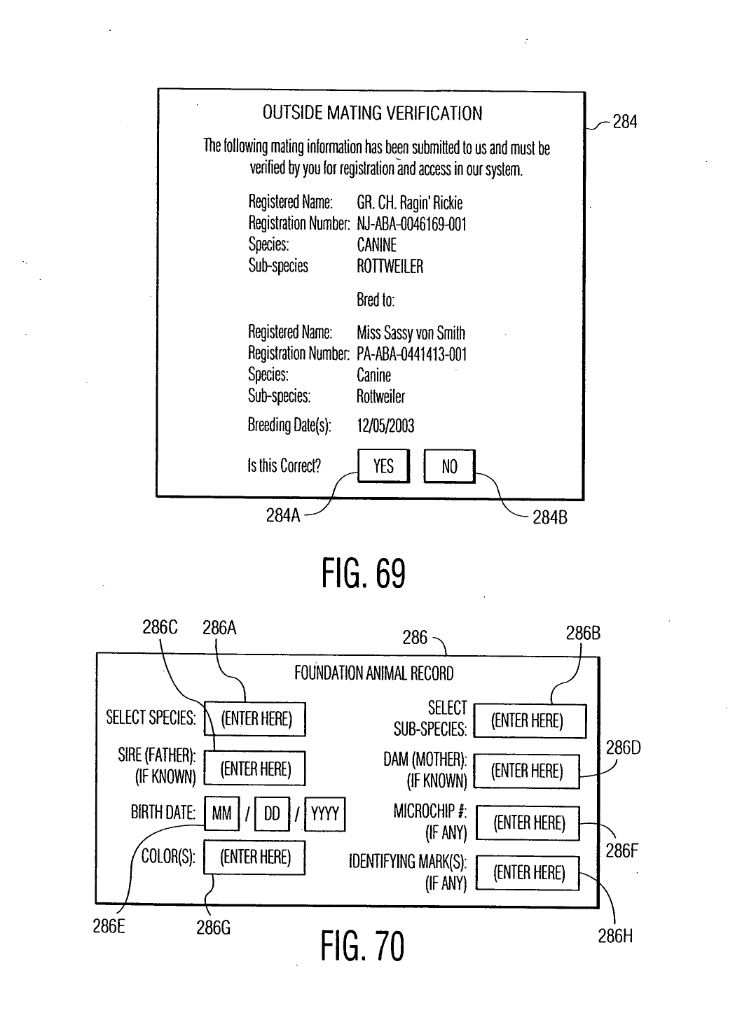

When the owner of the Outside Male is ready to determine if the information is correct, the owner may select the illustrative message 282A stating “Click Here.” After the owner of the Outside Male selects message 282A, an Outside Mating Verification screen 284 may be displayed as illustrated in FIG. 69. Screen 284 illustrates a description of an illustrative female and an illustrative Outside Male. If the owner of the Outside Male agrees with the information entered by the owner of the female, the owner of the Outside Male may select “YES” in message 284A. The owner of the Outside Male may select “NO” in message 284B if the entered information is not correct.

Once the owner of the Outside Male verifies the information, either the owner of the Outside Male or the owner of the female may complete the information requested as illustrated in screen display 280 in FIG. 66. It may be desirable, however, that the owner of the female complete the Breeding Record.

The invention may also allow the owner of a male animal to record breeding information when the male is bred with a female that is not owned by the owner of the male and is not registered in the system's database. The invention may operate in the same way as the system operates when the owner of a female animal records breeding information when an outside male is used.

It will be understood that the system and method described in connection with FIG. 65 through FIG. 69 may be used when the parentage of both the male and the female are known.

FIG. 70 may allow a user to register an offspring of a male and a female when the complete parentage of either the male, or the female, or both the male and the female are not known. When the parentage of a animal used for breeding is not known, the animal may be known as “Foundation Stock.” Foundation Animal Record 286, illustrated in FIG. 70, may be used for this purpose. Screen 286 may allow the breeder, original owner, pet store, or new owner to enter information about the offspring. In an exemplary embodiment of the invention, the type of species may be entered in Select Species field 286A, the type of Sub-Species may be entered in Select Sub-Species field 286B, the name and identification number of the Sire (Father), if known, may be entered in field 286C, the name and identification number of the Dam (Mother), if known, may be entered in field 286D, the Birth Date of the offspring may be entered in field 286E, a microchip number assigned to the offspring may be entered in field 286F, the color or colors of the offspring may be entered in field 286G, and any identifying mark or marks may be entered in field 286H.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method for use with a computer system for registering information by at least one authorized user relating to at least one animal, the method comprising:
entering information into the computer system about the user;
entering information into the computer system about the animal;
correlating the information about the user with the information about the animal; and
storing the correlated information in the computer system.

2. The method of claim 1, wherein entering information about the animal includes entering at least one of the animal's name, breed, sex, color, microchip number, tattoo number, and tattoo location.

3. The method of claim 1, wherein entering information about the user includes entering at least one of a name, an address, a telephone number, and an e-mail address of the user.

4. The method of claim 3, wherein the user is one of an owner, a breeder, a distributor, and a pet store.

5. The method of claim 1, further comprising generating a registration application number for the animal, creating an identification number for the animal, and generating an Internet access security code.

6. The method of claim 5, wherein generating an Internet access security code is based on the identification number for the animal and the state where the animal resides.

7. The method of claim 6, further comprising printing a registration application form.

8. The method of claim 1, further comprising generating a registration application number for the animal, creating an identification number for the animal, and generating a random Internet access security code.

9. The method of claim 1, further comprising paying a registration company by using one of a prepaid coupon, a credit card, and a debit card.

10. The method of claim 2, further comprising determining if the entered animal name has previously been assigned to another animal and identifying at least one alternative name for the animal.

11. The method of claim 1, further comprising coupling the computer system to a global communication network.

12. The method of claim 1, wherein the computer system comprises a server and at least one client system.

13. The method of claim 12, wherein at least a portion of the information is stored on the server.

14. The method of claim 12, wherein at least a portion of the information is retrieved from the server by the at least one client system.

15. The method of claim 1, further comprising assigning a unique registration number to the animal.

16. The method of claim 1 further comprising:
entering information into the computer system about offspring of the animal;
correlating the information about the user with the information about the animal and the offspring of the animal; and
storing in the computer system the information correlated about the user, the animal, and the offspring of the animal.

17. The method of claim 16, further comprising assigning a unique registration number to the offspring of the animal, the offspring registration number being different than the animal registration number.

18. The method of claim 1, further comprising printing at least a portion of the stored information.

19. A method for use with a computer system for storing a breeding history of an animal offspring in a computer system, the method comprising
entering information into the computer system identifying a male animal that is bred to produce the offspring;
entering information into the computer system identifying a female animal that is bred to produce the offspring;
entering information into the computer system identifying the offspring animal produced by the male animal and the female animal;
correlating in the computer system the information about the male animal, the female animal, and the offspring animal; and
storing the correlated information in the computer system.

20. The method of claim 19, further comprising:
entering into the computer system the date of breeding between the male animal and the female animal; and
storing in the computer system the date of breeding.

21. The method of claim 19, further comprising:
entering into the computer system the date of birth of the offspring animal; and
storing in the computer system the date of birth of the offspring animal.

22. The method of claim 19, further comprising:
entering into the computer system a name of the offspring animal; and storing in the computer system the name of the offspring animal.

23. The method of claim 19, further comprising;
entering into the computer system a name of the offspring animal;
determining the availability of the name for the offspring animal;
providing at least one alternative name of the offspring animal; and
storing one of the name of the offspring animal or the alternative name of the offspring animal.

24. The method of claim 19, further comprising printing at least a portion of the stored information.

25. The method of claim 24, further comprising printing a breeding record of the offspring animal.

26. A method for use with a computer system for registering information by at least one authorized user relating to at least one animal, the method comprising:
(a) entering information into the computer system about the user;
(b) assigning a unique registration number to the animal;
(c) entering information into the computer system about the animal, the information including at least one of the animal's name, breed, sex, color, microchip number, tattoo number, and tattoo location;
(d) identifying at least one alternative name for the animal if the entered animal name has previously been assigned to another animal;
(e) correlating the information about the user with the animal's unique registration number and the information about the animal;
(f) storing the correlated information in the computer system; and
(g) printing at least a portion of the stored information.

27. The method of claim 26, further comprising generating a registration application number for the animal via a connection to a global information network, creating an identification number for the animal, and generating an access security code.

28. The method of claim 27, wherein generating an Internet access security code is based on the identification number for the animal and the state where the animal resides and further comprising printing a registration application form and generating a registration certificate.

29. The method of claim 26, further comprising generating a registration application number for the animal, creating an identification number for the animal, and generating a random access security code.

30. The method of claim 26, further comprising paying for the registration application using at least one of an indication of prepayment or an online payment.

31. The method of claim 27, wherein generating the registration application number includes providing at least one of the registration application number, the access security code, and a store code.

32. The method of claim 26, further comprising:
(h) entering information into the computer system about offspring of the animal;
(i) assigning a unique registration number to the offspring of the animal, the offspring registration number being different than the animal registration number;
(j) correlating the information about the user with the information about the animal, the information about the offspring, unique registration of the animal, and the unique registration number of the offspring; and
(k) storing in the computer system the information correlated in (j).

33. A method for use with a computer system for storing a breeding history of an animal offspring in a computer system, the method comprising:
entering information into the computer system identifying a male animal that is bred to product the offspring;
entering information into the computer system identifying a female animal that is bred to produce the offspring;
entering information into the computer system identifying the offspring animal produced by the male animal and the female animal;
entering into the computer system the date of breeding between the male animal and the female animal;
entering into the computer system the date of birth of the offspring animal;
correlating in the computer system the information about the male animal, the female animal, and the offspring animal, the date of breeding, and the date of birth; and
storing the correlated information and at least one of the date of breeding and the date of birth in the computer system.

34. The method of claim 33, further comprising:
entering into the computer system a name of the offspring animal; and storing the name of the offspring animal in the computer system.

35. The method of claim 33, further comprising:
entering into the computer system a name of the offspring animal;
determining the availability of the name for the offspring animal;
providing at least one alternative name of the offspring animal; and
storing one of the name of the offspring animal or the alternative name of the offspring animal in the computer system.
